(19) United States
(12) Patent Application Publication
(10) Pub. No.: US 2004/0184479 A1
(43) Pub. Date: Sep. 23, 2004

(54) Packet routing device and packet routing method

(76) Inventors: Hiroki Yamauchi, Ibaraki-shi (JP); Minobu Abe, Hirakata-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/632,859

(22) Filed: Aug. 4, 2003

(30) Foreign Application Priority Data
Aug. 6, 2002 (JP) 2002-229100

(51) Int. Cl. H04J 3/16

(52) U.S. Cl. 370/466

(57) ABSTRACT

The present invention provides a packet routing device capable of converting packet data complying with one of a plurality of secure protocols received via an external network into the one complying with a secure protocol used for a home network at home.

A packet routing device 101 includes a first network I/F unit 201, a decryption unit 202, a protocol conversion unit 203, an encryption unit 204, a second network I/F unit 205 and a memorizing unit 801. The first network I/F unit 201 receives the packet data complying with one of the secure protocols used for the external network. Then, the protocol conversion unit 203 converts the received packet data into the one complying with a secure protocol used for the home network, with reference to a table 802 memorized by the memorizing unit 801.

### TECHNICAL FIELD

The present invention relates to a packet routing device for transmissions using packet data and its method, especially to techniques for performing protocol conversion for encrypted packet data.

### BACKGROUND ART

Recently, an access network that is an always-connected broadband such as ADSL (Asymmetric Digital Subscriber Line) and a fiber optic network and the like for transmitting massive communication contents has rapidly come into wide use even at household level. A large number of home networks combining organically the home electric appliances in the household are in process of standardization. ECONET, IEEE1394 and Home PNA can be cited as its representative examples.

It is anticipated that a user can remotely control these home electric appliances by controlling a portable terminal that is connectable to the Internet from the place where the user has gone and by transmitting control information to the home electric appliances at home via the Internet or a home network. Thus controlling remotely the home electric appliances improves the convenience for the users and attaches a new value to the home electric appliances. This, in turn, brings an enhancement of the added value of the products to the consumer electronics makers.

The remote control presupposes that trustful and secure transactions be made between a service provider side and a user side. However, a risk of mechanical errors can be caused by a malicious third person falsifying the remote control information in the case of using the Internet, indoor/outdoor wireless networks, electric line networks, which cannot always prevent interception and falsification of the information while the remote control information is transmitted. Specially in the case of controlling a heater or a hot water supplier, there is a risk of causing a fire due to the errors.

As methods to solve such problems, encrypting the contents of the transmissions and putting hash values for detecting falsification can be introduced. The groups working for the standardization of various kinds of network protocols have a security enhancement as an assignment and are working on the attachment of the security function to the protocols. Encrypted communication protocols such as L2TP (Layer Two Tunneling Protocol), IPsec (IPv4 version, IPv6 version), SSL (Secure Sockets Layer) and the encryption compliant ECONET are standardized as a fruit of these attempts. These encrypted communication protocols include, as an encryption algorithm, DES (Data Encryption Standard), 3DES (Triple DES) and AES (Advanced Encryption Standard), which can partly decrypt an arbitrary area of the encoded data.

The problem in realizing the remote control of the home electric appliances is the case in which the encrypted communication protocol used for the Internet outdoor and the one used at home for the home network differs. In this case, a packet routing device for converting these encrypted communication protocols is required.

The encrypted communication system that allows the terminals using different encryption codes to perform safely encryption conversion processing for encrypted communications is disclosed (i.e., see reference to Japanese Laid-Open Patent No.2001-211421).

Now it is a transition period for the protocol type used for the Internet as mentioned above, various kinds of protocols are standardized in order to enhance security, all of which are introduced as new secure protocols. These new secure protocols include IPsec, SSL and ECONET which is encryption compliant. An appearance of a routing device that receives packet data transmitted from an external network using a plurality of these secure protocols and transmits the packet data to each destination of the home electric appliances after receiving the packet data complying with one of these plural secure protocols and then converting it to a secure protocol for a home network is desired.

The conventional packet routing device decrypts and encrypts not only the header part but also the payload part whose information volume is greater than that of the header part, of the encrypted information stored in the packet data, in order to acquire communication control information stored in the header part, the trailer part and the like contained in the encryption packet data even when the indoor and outdoor encrypted communication protocols share an algorithm and an encryption key with which the packet data can be partly decrypted.

FIG. 22 is a diagram showing a process of packet data processing of the conventional packet routing device. Packet data 2201 is comprised of plaintext control information 310, encrypted communication control information 320, which have relatively a less amount of information, and encrypted user information 330 which has a great amount of information. The packet routing device then performs protocol conversion for the packet data 2201 received from a first network I/F unit 201 connected via a communication network and outputs it as packet data 2202 from a second network I/F unit 205.

As shown in FIG. 22, the conventional routing device has to decrypt the whole data area of the packet data 2201 including the user information 330 which normally needs not be decrypted as decrypted user information 2230 for the decryption of the data area to be decrypted. Then, the protocol conversion for decrypted communication control information 500 and the plaintext communication control information 310 is performed, and furthermore, the packet data 2202 including the decrypted user information 2230 and others needs to be encrypted again before transmitting the information of the packet data 2202 to the second network I/F unit 205.

However, when outputting the packet data that is compliant with a communication protocol for a communication network and received from a terminal device connected via the communication network, complying with a different communication protocol adapted to other communication network, the conventional packet routing device repeats encrypting and decrypting the whole data area of the packet data including the user information which normally does not need to be decrypted with the view to acquire the communication control information stored in the header part, the trailer part or the like within the encrypted packet data.

Generally speaking, a realization of the protocol conversion processing with high speed requires an expensive high-end CPU and dedicated hardware because encryption and decryption requires many processing steps. Therefore, the packet routing device requires expensive components and costs greatly while providing the user with convenience such as a remote control for the home electric appliances.

It is also a problem that the malicious third person can easily intercept the highly confidential user information or the like since the decryption of the user information and the like is performed when the packet routing device decrypts the packet data.

### DISCLOSURE OF INVENTION

The present invention has been conceived in view of the aforementioned circumstances, and the first object of this invention is to provide a packet routing device which can receive packet data from an external network using plural secure protocols and convert the packet data into the one complying with a secure protocol used for the home network at home.

The second object is to provide a packet routing device which allows high-speed protocol conversion processing for encrypted communications in the case using a low-priced and low-performance CPU or the like. Furthermore, the third object is to provide a packet routing device which can ensure security in the routing processing of the packet data including highly confidential information and prevent an interception or the like attempted by a malicious third person.

In order to achieve the above objects, the packet routing device according to the present invention for routing packet data to be transmitted between an external network and a home network comprises: a reception unit operable to receive the packet data complying with one of a plurality of secure protocols from the first terminal device via the external network; a judgment unit operable to judge types of secure protocols, encryption algorithms and encryption keys used for communications via the external network and communications via the home network; a conversion unit operable to convert the secure protocol for the packet data received by the reception unit into a second secure protocol for the home network, based on the judgment made by the judgment unit; and an outputting unit operable to output, to the second terminal device, the packet data whose protocol has been converted by the conversion unit.

Thus, the packet routing device according to the present invention allows the user to remote control home electric appliances by transmitting safely the packet data to which control information is attached from the terminal device complying with a various secure protocols for the external network to the terminal device on the home network used at home and thus improves the convenience for the user.

Also, in the packet routing device according to the present invention, the packet data received by the reception unit contains a header part including plaintext communication control information and encrypted communication control information, and a main part including encrypted user information, and the packet routing device further comprises: an identification unit operable to identify the encrypted communication control information from the received packet data; a decryption unit operable to decrypt the identified encrypted communication control information; and a packet generation unit operable to generate packet data whose protocol is converted by the conversion unit, the packet data including the decrypted communication control information and the user information, wherein the conversion unit converts the communication control information decrypted by the decryption unit into communication control information complying with the second secure protocol, and the outputting unit outputs the packet data generated by the packet generation unit to the second secure protocol.

Consequently, with the use of the packet routing device of the present invention, the user information having a greater data volume compared with the communication control information is not decrypted. This reduces the number of executions for decryption processing which requires many processing steps and thereby realizes a packet routing device that can perform high-speed protocol conversion processing even in the case of using a low-priced and low performance CPU or the like.

The present invention realizes the routing device as described above but also as a routing method having the units included in the routing device as steps and as a program for realizing the routing method in the computer system or the like. The program can be distributed via a storage medium such as DVD, CD-ROM and the like as well as a transmission medium such as a communication network or the like.

The packet routing device according to the present invention allows the user to remote control by transmitting the packet data to which control information is attached from a terminal device complying with a various secure protocols for the external network to the terminal device on the home network used at home and improves the convenience for the user.

Also, the user information that contains a greater data amount than the communication control information is not decrypted, therefore, it is possible to reduce the number of executions for decryption processing which requires many processing steps. This realizes the packet routing device that can perform high-speed protocol conversion processing for encrypted communications even in the case of using a component such as a cheap and low-performance CPU or the like and is adapted for the recent tendency for transmissions of massive contents.

Also, the storage position of the encrypted communication control information can be easily identified even in the case in which the encrypted communication control information included in the packet data is variable. Owing to this, the number of executions for decryption processing which requires many processing steps can be surely reduced and a packet routing device that can provide a high-speed protocol conversion processing for encrypted communications can be realized.

Consequently, the user information remains encrypted during the processing of the packet data operated by the routing device, therefore, this prevents the highly confidential information from being intercepted by a malicious third person.

As for further information about technical background to this application, Japanese Patent Application No.2002-229100 filed 6 Aug., 2002, is incorporated herein by reference.

### BRIEF DESCRIPTION OF DRAWINGS

FIG. 1 is a diagram showing an example of a structure of a network system including a packet routing device according to a first embodiment.

FIG. 2 is a functional block diagram showing a structure of the packet routing device according to the first embodiment.

FIG. 3 is a diagram showing a data structure of packet data used in the first embodiment.

FIG. 4 is a flowchart showing an operation procedure of the packet routing device according to the first embodiment.

FIG. 5 is an illustration showing a process of packet data processing according to the first embodiment.

FIG. 6 is an illustration showing a process of protocol conversion processing of the packet data, performed by the packet routing device according to the first embodiment.

FIG. 7 is a diagram showing an example of a structure of a network system including a packet routing device according to a second embodiment.

FIG. 8 is a functional block diagram showing an example of a structure of the packet routing device according to the second embodiment.

FIG. 9 is a flowchart showing an operation procedure of the packet routing device according to the second embodiment when the packet data is transmitted from a terminal device on an external network to terminal devices at home.

FIG. 10 is a flowchart showing an operation procedure of the packet routing device according to the second embodiment when the packet data is transmitted from the terminal device on the external network to the terminal devices at home.

FIG. 11 is an illustration showing a process of protocol conversion processing of the packet data, performed by the packet routing device according to the second embodiment.

FIG. 12 is an illustration showing a process of another protocol conversion processing of the packet data, performed by the packet routing device according to the second embodiment.

FIG. 13 is a diagram showing an example of a structure of a network system including a packet routing device according to a third embodiment.

FIG. 14 is a functional block diagram showing a structure of the packet routing device according to the third embodiment.

FIG. 15 is a diagram showing a data structure of the packet data used in the third embodiment.

FIG. 16 is a flowchart showing an operation procedure of the packet routing device according to the third embodiment.

FIG. 17 is a flowchart showing an operation procedure of the packet routing device according to the third embodiment.

FIG. 18 is a diagram showing a data structure of packet data used in a fourth embodiment.

FIG. 19 is a flowchart showing an operation procedure of a packet routing device according to the fourth embodiment.

FIG. 20 is an illustration showing a process of protocol conversion processing of the packet data, performed by the packet routing device according to the fourth embodiment.

FIG. 21 is a diagram showing an example of a data structure of the packet data used for the present invention.

FIG. 22 is a diagram showing a process of packet data processing performed by the conventional packet routing device.

### BEST MODE FOR CARRYING OUT THE INVENTION

These and other objects, advantages and features of the invention will become apparent from the following description thereof taken in conjunction with the accompanying drawings that illustrate a specific embodiment of the invention. In the Drawings:

(First Embodiment)

The following describes a packet routing device 101 according to a first embodiment of the present invention.

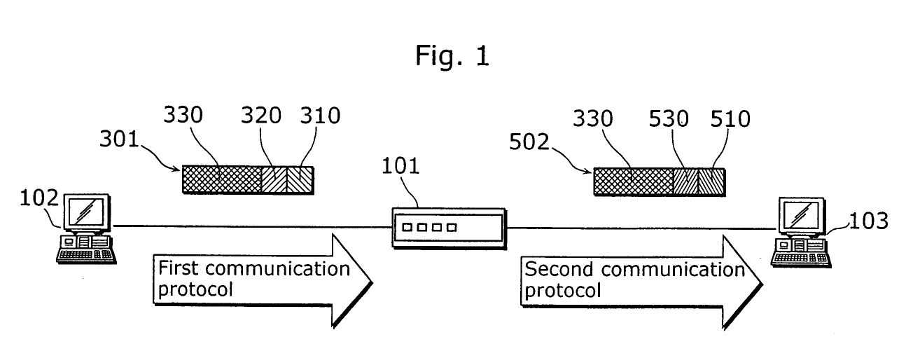

FIG. 1 is a diagram showing an example of a structure of a network system including the packet routing device 101 of the first embodiment.

The packet routing device 101 of the first embodiment is a device for outputting an inputted IP packet by reconstructing it as a packet after performing encryption (including decryption) processing and protocol conversion on a block-by-block basis necessary for the IP packet. The packet routing device 101 is characterized by an operation of decryption, protocol conversion and encryption processing executed only for the encrypted communication control information 320 of the packet data 301. A first terminal device 102 and a second terminal device 103 are connected via the packet routing device 101 to establish a network system.

The first terminal device 102 is connected to a first network and applies a first communication protocol for encrypted communications whereas the second terminal device 103 shown in FIG. 1 is connected to a second network and applies a second communication protocol for encrypted communications. The first network is, for instance, Internet whereas the second network is a communication network for household use such as ECONET or the like.

In FIG. 1, the packet routing device 101 that understands two different encryption protocols and converts the data from one encrypted communication protocol to the other is set between the first terminal device 102 and the second terminal device 103 since the encrypted communication protocols employed at each terminal device are different.

The packet data 301 transmitted from the first terminal device 102 to the packet routing device 101 contains plaintext control information 310, the encrypted communication control information 320 and encrypted user information 330 whereas the packet data 502 outputted from the packet routing device 101 to the second terminal device 103 contains plaintext control information 510, encrypted communication control information 530 and the encrypted user information 330. The packet routing device 101 performs protocol conversion for the packet data 301 to be converted as packet data 502 complying with the second communication protocol different from the one used for the first terminal device 102.

The prerequisites for the application of the present embodiment is that the first terminal device 102 and the second terminal device 103 share an encryption algorithm and an encryption key and that DES (Data Encryption Standard), 3DES, AES (Advanced Encryption Standard), with ECB (Electronic Code Book) mode, which can partly decrypt an arbitrary area in the encrypted data, or the like is applied to the encryption algorithm. The first terminal device 102, the second terminal device 103 and the packet routing device 101 shall share the encryption algorithm and the encryption key in one way or another before starting the transmissions.

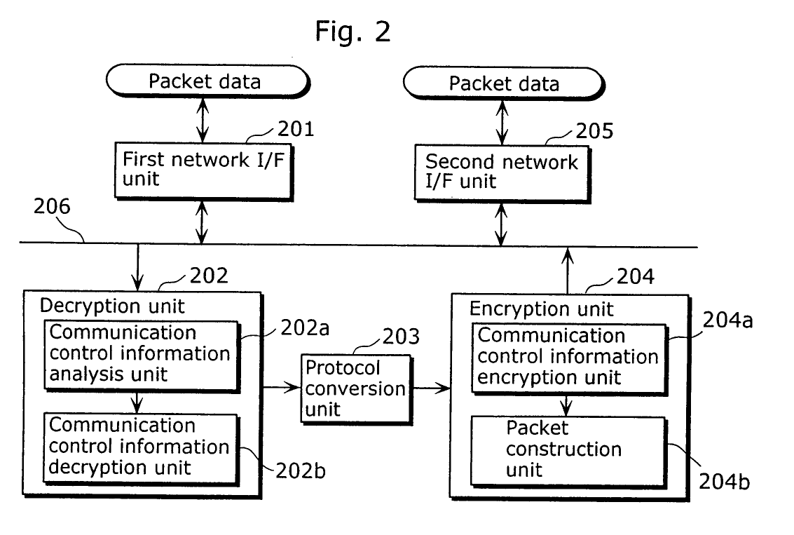

FIG. 2 is a functional block diagram showing a structure of a packet routing device 101. The packet routing device 101 is an intermediary device such as a home server, a router and the like and includes a first network I/F unit 201, a decryption unit 202., a protocol conversion unit 203, an encryption unit 204, a second network I/F unit 205 and a bus 206 which transmits the packet data 301. Each of the components shown in the functional block diagram FIG. 2 is an example for the description of the present embodiment, and the structure of the packet routing device 101 according to the present invention is not restricted to the one shown in FIG. 2.

The first network I/F unit 201 is an interface circuit or the like for the transmission of the packet data 301 to and from the first terminal device 102 via the first network I/F unit 201. The decryption unit 202, consisting of a communication control information analysis unit 202a and a communication control information decryption unit 202b, decrypts the packet data 301 received by the first network I/F unit 201 (or the second network I/F unit 205) in compliance with the first communication protocol and outputs it to the protocol conversion unit 203. The communication control information analysis unit 202a analyses a data length of the encrypted communication control information 320 using the plaintext communication control information 310 included in the packet data 301. The communication control information decryption unit 202b decrypts only the data length that needs to be decrypted, starting from the head position of the communication control information 320, based on the analyzed data length.

The protocol conversion unit 203 receives the packet data 301 outputted from the decryption unit 202, performs protocol conversion for the data so that the encryption protocol is converted into the one complying with the second communication protocol and outputs the result of the protocol conversion to the encryption unit 204.

The encryption unit 204 consists of a communication control information encryption unit 204a and a packet construction unit 204b. The communication control information encryption unit 204a encrypts the packet data 502 whose protocol has been converted by the protocol conversion unit 203 whereas the packet construction unit 204b executes the construction of the packet and outputs it to the second network I/F unit 205. The second network I/F unit 205 is an interface circuit for the transmission of the packet data to and from the encryption unit 204 and also for the transmission to and from the second terminal device 103 via the second network I/F unit 205.

The decryption unit 202, the protocol conversion unit 203 and the encryption unit 204 can be realized with a CPU, a ROM in which control program is stored, a RAM as a work area or the like.

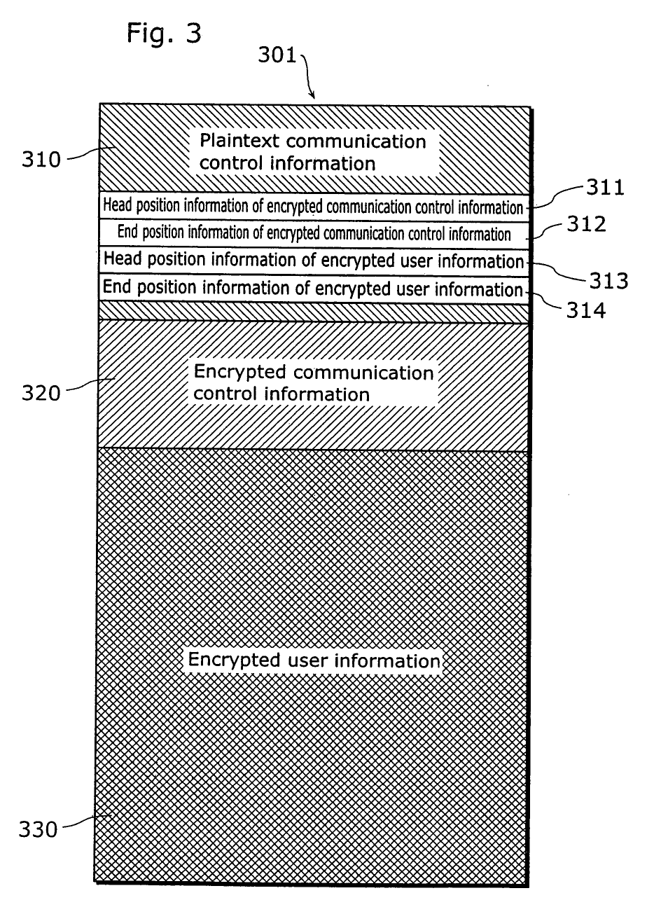

FIG. 3 is a diagram showing a data structure of the packet data 301 used in the first embodiment. The packet data 301, with a length of, for instance, 1500 bytes, includes the plaintext communication control information 310, the encrypted communication control information 320 and the encrypted user information 330, starting from the head of the data. In the first embodiment, the encrypted communication control information 320 has, for example, a data length of 10 bytes, which is assumed to be variable.

The plaintext communication control information 310 includes head position information 311 as well as end position information 312 of the encrypted communication control information 320 that are necessary for decrypting the encrypted communication control information 320 and the encrypted user information 330, head position information 313 as well as end position information 314 of the encrypted user information 330 and other routing information etc. The head position information 311 identifies the head position whereas the end position information 312 identifies the end position respectively of the encrypted communication control information 320 included in the packet data 301. The head position information 313 identifies the head position whereas the end position information 314 identifies the end position respectively of the encrypted user information 330 included in the packet data 301.

The encrypted communication control information 320 is used for an end terminal for encrypted communications and includes information which does not want to be intercepted during the communications or the like whereas the encrypted user information 330 is used for both terminals for encrypted communications and includes also the information which shall not be intercepted during the communications or the like.

The following describes an operation of the packet routing device 101 according to the first embodiment constructed as described above.

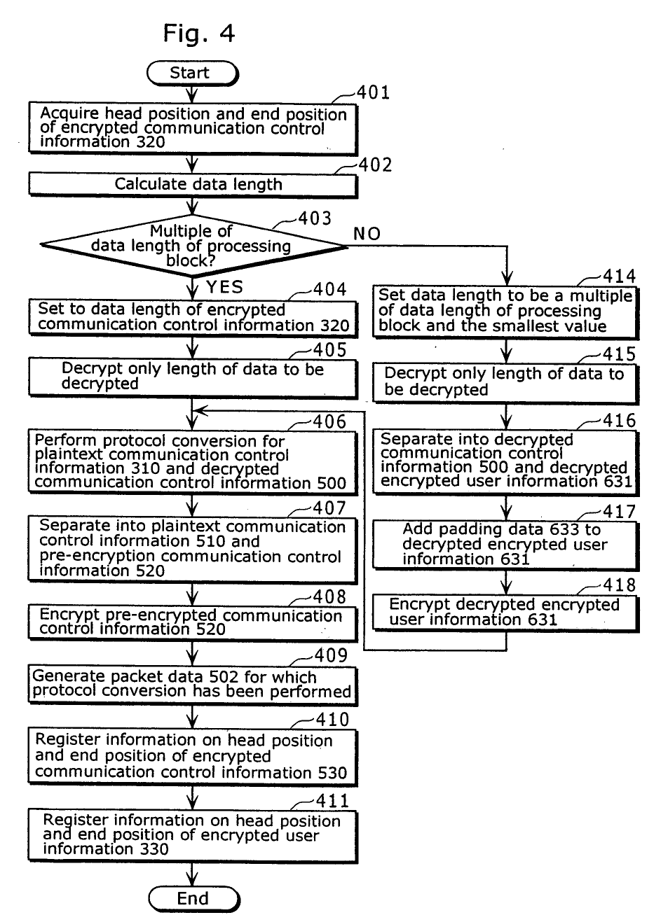

FIG. 4 is a flowchart showing an operation procedure of the packet routing device 101 according to the first embodiment. The communication control information analysis unit 202a included in the decryption unit 202 acquires the head position information 311 and the end position information 312 of the encrypted communication control information 320 from the plaintext communication control information 310 in the packet data 301 transmitted from the first network I/F unit 205 (Step 401). Then, the communication control information analysis unit 202a calculates the data length of the encrypted communication control information 320 by subtracting an address value of the head position information 311 from an address value of the end position information 312 (Step 402) and analyzes whether the data length of the encrypted communication control information 320 is a multiple of a data length of a processing block used for encryption algorithm (Step 403).

When the analysis shows that the data length of the encrypted communication control information 320 is not a multiple of the data length of the processing block used for encryption algorithm, the analysis unit 202a sets the length of the data to be decrypted as a value that is a multiple of the data length of the processing block used for encryption algorithm which goes beyond the data length of the encrypted communication control information 320 and the smallest (Step 414).

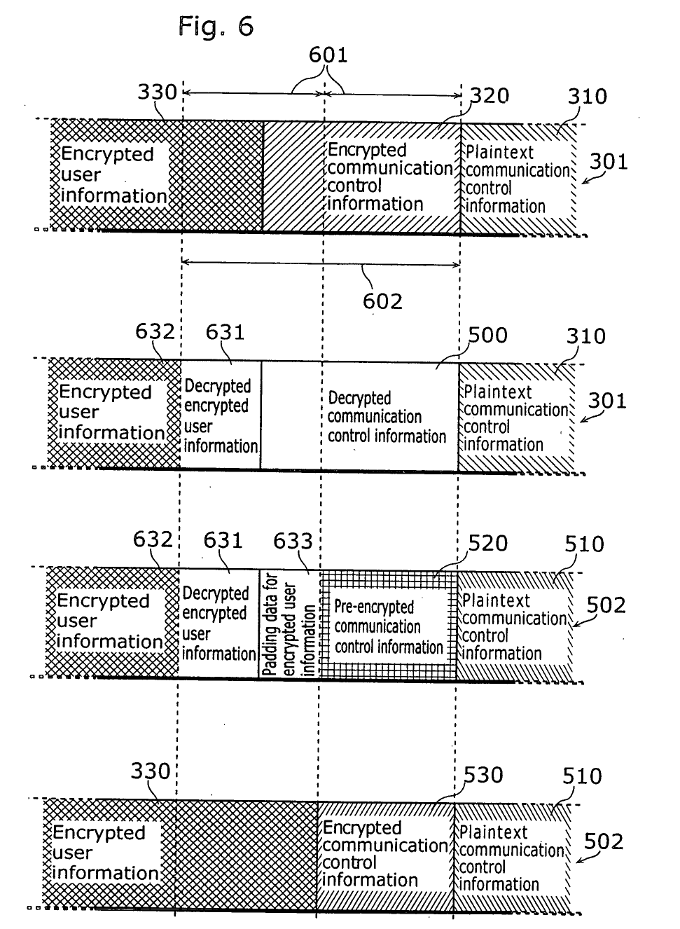

Then, the communication control information decryption unit 202b decrypts the data length starting from the head position of the encrypted communication control information 320, that is, a range of the data indicated by a data range to be decrypted 602 shown in FIG. 6 (Step 415). At the time of terminating the decryption (Step 415), decrypted communication control information 500 shown in FIG. 6 is generated. The data decrypted in Step 415 is separated into the decrypted communication control information 500 and decrypted encrypted user information 631 shown in FIG. 6 (Step 416), and the decrypted communication control information 500 is copied, for instance, to other memory area in the RAM.

The protocol conversion unit 203 adds padding data for encrypted user information 633 to the encrypted user information 631 so that the decrypted encrypted user information 631 equals to the data length of the processing block used for encryption algorithm shown in. FIG. 6 (Step 417). The communication control information encryption unit 204a encrypts the encrypted user information 631 and the padding data 633 as encrypted user information 330 (Step 418).

The protocol conversion unit 203 then generates newly plaintext communication control information 510 and pre-encrypted communication control information 520 by performing protocol conversion for the plaintext communication 310 and the decrypted communication control information 500, complying with the first communication protocol, so that they comply with the second communication protocol (Step 406) and then separates the communication control information compliant with the second secure protocol into plaintext communication control information 510 and pre-encrypted communication control information 520 (Step 407).

Then, the communication control information encryption unit 204a included in the encryption unit 204 then encrypts the pre-encrypted communication control information 520 and generates encrypted communication control information 530 (Step 408). After that, the packet construction unit 204b combines the plaintext communication control information 510, the encrypted communication control information 530 and the encrypted user information 330 and constructs packet data 502 (Step 409).

The packet construction unit 204b registers, in the plaintext communication control information 510, information on the head position and the end position of the encrypted communication control information 530 (Step 410) as well as the head position information and the end position information of the encrypted user information 330 (Step 411). When the registration (Step 411) is terminated, the construction of the packet data 502 is achieved and a sequence of protocol conversion for encrypted communications is completed.

On the other hand, when the analysis shows that the data length of the encrypted communication control information 320 is a multiple of the data length of the processing block used for encryption algorithm, the decryption unit 202 sets the data length to be decrypted as a data length of the encrypted communication control information 320 (Step 404) and decrypts only the data length thus set by the decryption unit 202 in Step 404 (Step 405). Then the protocol conversion unit 203 creates newly plaintext communication control information 510 and pre-encrypted communication control information 520 by performing protocol conversion for the plaintext communication control information 310 and the decrypted communication control information 500, complying with the first communication protocol, so that they comply with the second communication protocol (Step 406). The protocol conversion unit 203 then separates the communication control information compliant with the second communication protocol into plaintext communication control information 510 and pre-encrypted communication control information 520 (Step 407).

Then, the encryption unit 204 encrypts the pre-encrypted communication control information 520 and generates encrypted communication control information 530 (Step 408). After that, the packet construction unit 204b combines the plaintext communication information 510, the encrypted communication control information 530 and the encrypted user information 330 and constructs packet data 502 (Step 409). The packet construction unit 204b then registers, in the plaintext communication control information 510, information on the head position as well as the end position of the encrypted communication information 530 (Step 410) and also the head position information as well as the end position information of the encrypted user information 330 (Step 411). Thus, the construction of the packet data 502 is achieved and a sequence of protocol conversion for encrypted communications is thereby completed.

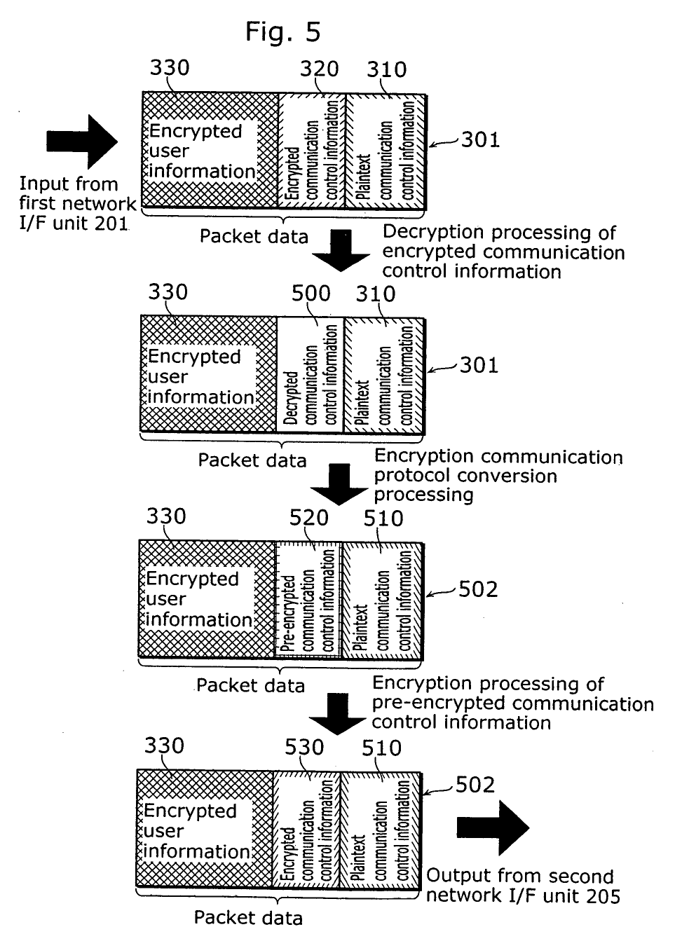

FIG. 5 is an illustration showing a process of packet data processing performed by the packet routing device 101 of the first embodiment. The packet data 301 is data to be inputted from the first network I/F unit 201 to the packet routing device 101 and includes the plaintext communication control information 310, the encrypted communication control information 320 and the encrypted user information 330.

The packet routing device 101 acquires the head position information 311 and the end position information 312 of the encrypted communication control information 320 from the plaintext communication control information 310, obtains the data length of the encrypted communication control information 320, decrypts only the part of the encrypted communication control information 320 as the decrypted communication control information 500.

Then, the packet routing device 101 then performs protocol conversion for the decrypted communication control information 500 and the plaintext communication control information 310 respectively as the pre-encrypted communication control information 520 and the plaintext communication control information 510.

Only the part of the pre-encrypted communication control information 520 of the packet data 502 is encrypted to be pre-encrypted communication control information 530. Then, the packet data 502 including the plaintext communication control information 510, the encrypted communication control information 530 and the encrypted user information 330 is constructed and then outputted from the second network I/F unit 205. In this way, a sequence of processing of the protocol conversion for the encrypted communications performed by the packet routing device 101 is completed.

FIG. 6 is an illustration showing a process of protocol conversion processing performed by the packet routing device 101. The DES, the 3DES, the AES or the like, which can partly decrypt an arbitrary area in the encrypted data, is used as an encryption algorithm during the processing.

The DES can encrypt the encrypted communication control information 320, for instance, using a unit of data length that is a multiple of 64 bits. FIG. 6 shows an example of a case in which the data length of the encrypted communication control information 320 is not a multiple of 64 bits. In FIG. 6, a data length of encryption processing block 601 and a data range to be decrypted 602 are indicated by double-headed-arrows. The data length of the encryption processing block 601 is set to 64 bits, for instance.

The communication control information 320 is information on IPv6, ECONET and others, and the data length of the communication control information 320 cannot be decrypted with the use of the arbitrary data length using the encryption algorithm. Therefore, the data range that needs to be decrypted is defined to be the data range 602, an equivalent of two blocks of the data length of the processing block used for encryption including a part of the encrypted user information 330 which normally does not require decryption.

Then, protocol conversion is performed for the decrypted communication control information 500 so that its data length is compressed to be the data length of the processing block used for encryption. In this case, padding data for encrypted user information 633 is added to the decrypted encrypted user information 631 so that the data length of the decrypted encrypted user information 631 equals to the professing unit data length of the encryption algorithm.

The padding data 633 and the decrypted encrypted user information 631 are encrypted as encrypted user information 330 and also the pre-encrypted communication control information 520 is encrypted as encrypted communication control information 530. Then, the packet data 502 including the converted communication control information 510, 530 and the user information 330 is generated.

Thus, the packet data 301 inputted to the packet routing device 101 includes position information 311 and 312 indicating a location to store the communication control information 320 in order to identify it.

The conventional routing device has had to encrypt or decrypt the whole data area of the packet data that is encrypted in order to obtain the communication control information, however, in the present embodiment, the routing device does not have to do this and can decrypt only the area of the communication control information 320 included in the header part. Therefore, the decryption of the user information 330 that has a greater data amount than the communication control information 320 is abbreviated, which reduces the number of executions for decryption processing that requires many processing steps. This realizes a packet routing device that can perform protocol conversion processing for encrypted communications with high speed even in the case in which the terminal device uses a cheap and low-performance component such as the CPU or the like. Thus it is possible to provide the packet routing device adapted for the recent tendency of broadband and transmissions of massive communication contents.

Also, the packet routing device 101 of the first embodiment ensures security during the processing of the packet data 301 including the user information 330 which contains highly confidential information since the user information 330 remains encrypted in the process of protocol conversion processing. It is therefore easy to prevent interception or the like attempted by a malicious third person. Thus, the packet routing device 101 adapted for the conversion of the communication control information in a transition period of protocol types for Internet can be provided.

The plaintext communication control information 310 contained in the packet data 301 also includes the head position information 313 and the end position information 314 of the user information 330. Therefore, it is easy to identify the data area of the user information 330, and the repetitive process of decrypting and encrypting the whole area of the packet data is no longer required as has been the case conventionally. This leads to the decrease in the number of executions for decryption processing which requires numerous processing steps. The packet routing device can thereby realize high-speed processing of protocol conversion for encrypted communications even for the case in which the terminal device uses a cheap and low-performance component such as the CPU or the like.

With the use of the packet routing device 101 described in the first embodiment, the user information 631 at the data range of minimum requirement is decrypted by adding the padding data 633 to the decrypted encrypted user information 631 so that the decrypted encrypted user information 631 is encrypted again as a multiple of the encryption algorithm when the data length of the communication control information 320 is not a multiple of the data length of the processing block used for encryption algorithm. Thus, the decryption processing of the user information 330 which has a greater data amount compared with the communication control information 320 can be reduced, which leads to the minimization of the number of executions for the decryption processing of the packet data 301, and the high-speed protocol conversion processing can be realized even with the low-priced and low-performance CPU.

Each of the sizes of various kinds of data shown in the present embodiment is set as an example to make the description comprehensible and each of the values is not strictly limited. Although the present embodiment does not assume other various cases, other values can be surely replaced instead of the sizes.

The location relationship of the position information 311, 312, 313 and 314 included in the plaintext communication control information 310 shown in the present embodiment is an example and it shall not be limited to this. Also, the information 310, 320 and 330 included in the packet data 301 of the present embodiment are exemplified for the explanation, and other information may be included in the packet data. Similarly, the location relationship of the plaintext communication control information 310, the encrypted communication control information 320 and the user information 330 shall not be restricted to the one described in the present embodiment and the structure may be different. Namely, the encrypted communication control information 320 may be placed only before, only after or both before and after, the user information 330.

(Second Embodiment)

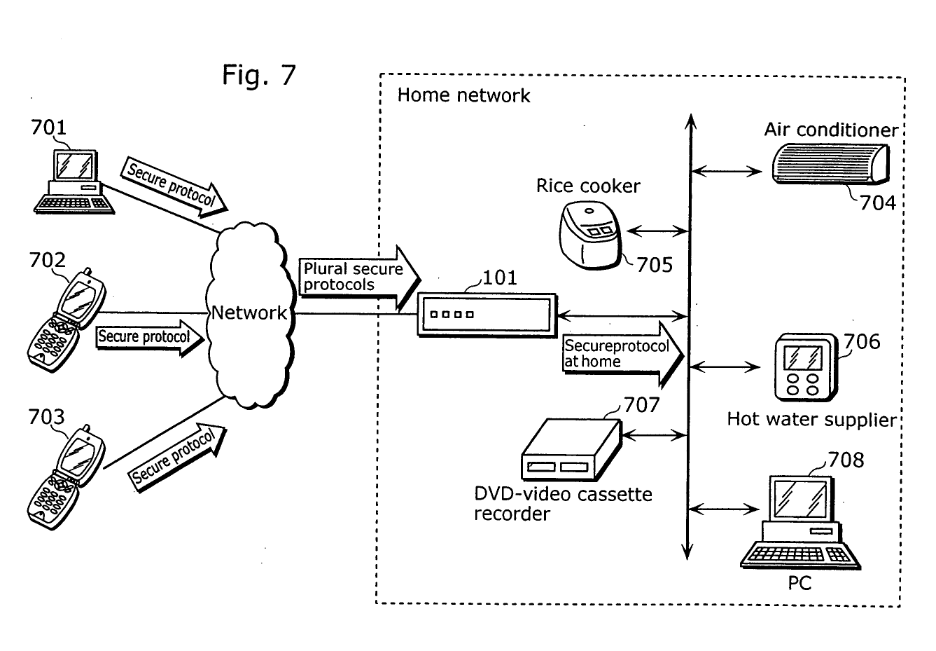

FIG. 7 is a diagram showing an example of a structure of a network system including a packet routing device 101 according to a second embodiment of the present invention.

In this network system, the user can send and receive safely control information between terminal devices such as a PC 701, a cell phone 702 or the like to be used outside and a rice cooker 705 and the like used at home by sending and receiving the packet data with the control information attached using a secure communication protocol.

The packet routing device 101 receives the packet data to be transmitted from the terminal device on the external network using various sorts of protocols as well as performs protocol conversion for the packet data to be compliant with the secure protocol used for the home network at home and transmits it to the home electric appliances.

The type of secure protocols used for an external network include IPsec, SSL, ECONET and the like and the ones used at home includes ECONET and others. As for the encryption algorithms used for these secure protocols, the DES, the 3DES, the AES or the like, with an ECB mode, which allows a partial decryption of an arbitrary area in the encrypted data can be employed. In this case, the packet routing device 101 is assumed to store information on the secure protocols used for both the external network and the home network, encryption algorithms and encryption keys in one way or another, for example, by registering beforehand the secure protocol in the case of using the external cell phone before starting the transmissions.

In FIG. 7, the PC 701 and the cell phone 702, that are terminal devices on the external network are connected via the network to the packet routing device 101 placed indoor. The terminal devices at home are connected to the external network via the packet routing device 101. The terminal devices at home are the home electric appliances used in the daily life, for instance, an air conditioner 704, a rice cooker 705, a hot water supplier 706, a video cassette recorder 707, a PC 708 and others. These home electric appliances are connected to one another via a home network using LAN. Thus, the network system is established by connecting the terminal device on the external network and the terminal devices placed indoor via the packet routing device 101.

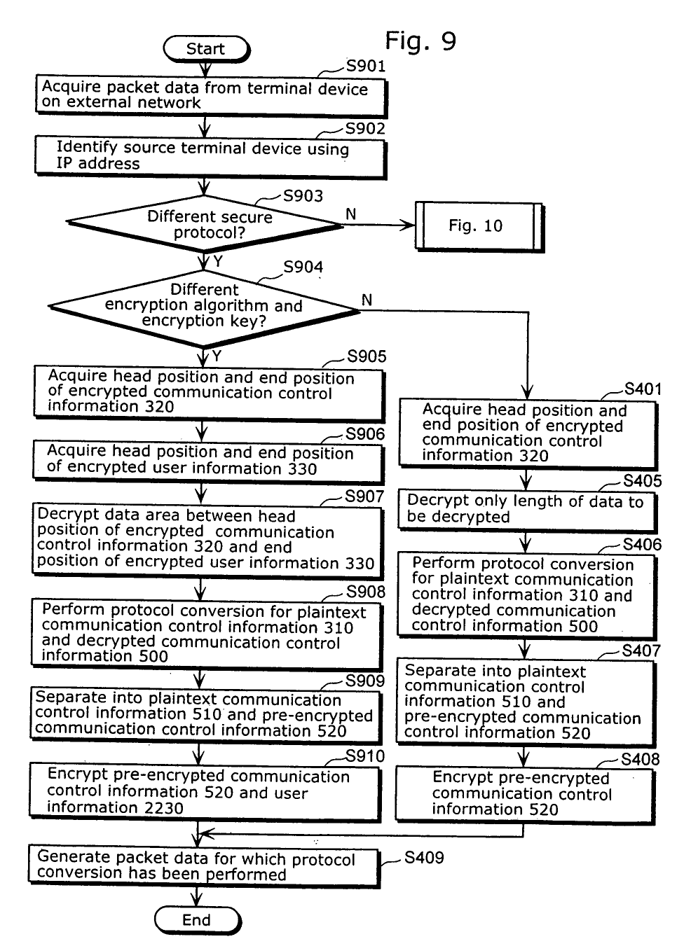

The packet routing device 101 according to the second embodiment reduces decryption and encryption processing that requires many processing steps, therefore, can perform processing of decryption, protocol conversion and encryption only for the encrypted communication control information 320 included in the packet data 301. The detail is described later on with reference to FIGS. 9 through 12.

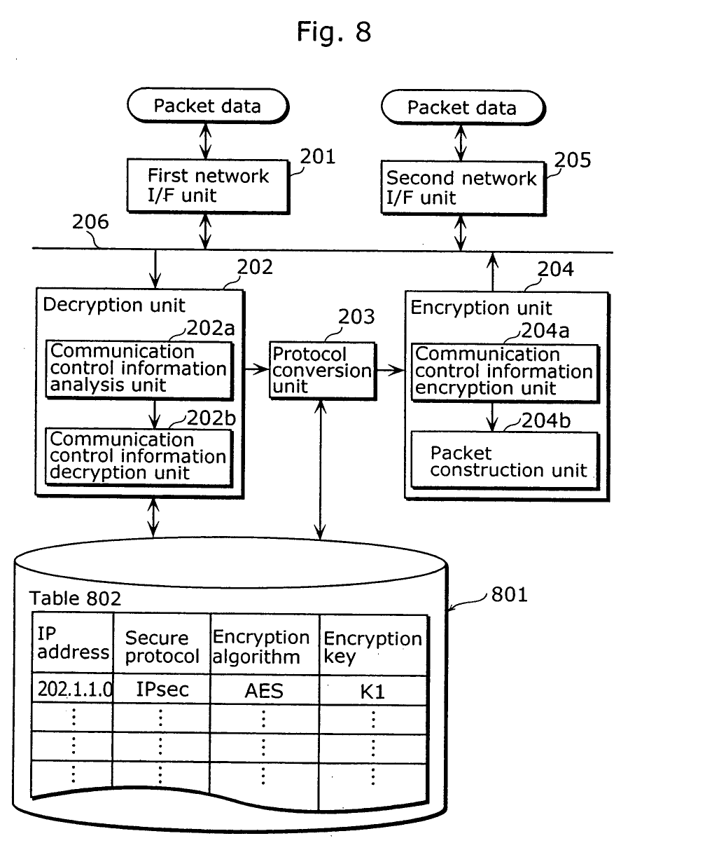

FIG. 8 is a functional block diagram showing an example of a structure of the packet routing device 101. The same marks are put for the same structure as the one used in the first embodiment and the detailed description is abbreviated.

The packet routing device 101 is characterized by having a memorizing unit 801 memorizing a table 802. Types of IP addresses, secure protocols, encryption algorithms and encryption keys for each of the terminal devices on the external network are memorized in the table 802. The IP address is numeric data presented, for example, using 32 bits, and also is information indicating an address of the terminal device and the router connected to the network.

The decryption unit 202 decrypts the packet data 301 received by the first network I/F unit 201 (or the second network I/F unit 205) according to the encryption algorithm and the encryption key used for the secure protocol for the external network and outputs it to the protocol conversion unit 203. Here, the decryption unit 202 specifies an IP address of a source terminal device by reading out the communication control information 310 in the received packet data 301 and specifies also the types of secure protocols, encryption algorithms and encryption keys corresponding to the IP address with reference to the table 802. The decryption unit 202 then decrypts only the part of the encrypted communication control information 320 when the external network and the home network share the encryption algorithm and the encryption key, and decrypts both the encrypted communication control information 320 and the user information 330 when they do not share the encryption algorithm and the encryption key, as described in the first embodiment.

The protocol conversion unit 203 receives the packet data 301 decrypted by the decryption unit 202. When the secure protocol used for the packet data 301 transmitted via external network differs from the one used for the home network, the protocol conversion unit 203 performs protocol conversion for the plaintext communication control information 310 and the encrypted communication control information 320 to be compliant with the secure protocol for the home network with reference to the table 802 memorized by the memorizing unit 801 and outputs to the encryption unit 204 the packet data 502 whose protocol is converted.

In the encryption unit 204, the communication control information encryption unit 204a encrypts the packet data 502 whose protocol is converted by the protocol conversion unit 203 with the use of the encryption algorithm and the encryption key used for the home network. Then, a packet including the communication control information 510, 530 and the user information 330 is constructed by the packet construction unit 204b and then outputted to the second network I/F unit 205. The second network I/F unit 205 then receives the packet data 502 from the encryption unit 204 and transmits it to the destination terminal devices at home.

The decryption unit 202, the protocol conversion unit 203 and the encryption unit 204 are realized with the CPU, the ROM in which control program is stored and the RAM as a work area or the like, as described in the first embodiment.

The following describes an operation of the packet routing device 101 according to the second embodiment that is constructed as described above.

FIG. 9 is a flowchart according to the second embodiment showing an operation procedure of the packet routing device 101 when transmitting the packet data 301 from the terminal device on the external network to the terminal devices at home. The diagram assumes a case in which the secure protocol used for communications via the external network differs from the one used for communications via a network at home.

Firstly, the first network I/F unit 201 acquires the packet data 301 when it is transmitted from the terminal device on the external network (S901). The decryption unit 202 reads out the communication control information 310 from the packet data 301 transmitted from the first network I/F unit 201 and acquires the IP address of the source terminal device. Then, the decryption unit 202 also identifies the destination terminal devices on the home network with reference to the acquired IP address and the table 802 memorized in the memorizing unit 801 (S902).

The decryption unit 202 then judges whether or not the secure protocol used for the source terminal device and the one used for the communication network at home differ with reference to the table 802 in order to identify the secure protocols (S903). The case in which the secure protocols differ (Y in S903) is described in the present diagram.

Then, the decryption unit 202 compares the secure protocol, the encryption algorithm and the encryption key used by the terminal device on the external network and those used by the terminal devices at home (S904). When the same encryption algorithm and encryption key are used at the both sides (N in S904), the communication control information analysis unit 202a included in the decryption unit 202 acquires the head position information 311 and the end position information 312 of the encrypted communication control information 320 using the plaintext communication control information 310′ in the packet data 301 which is transmitted from the first network I/F unit 201 (S401), calculates a data length of the encrypted communication control information 320 by subtracting an address value of the head position information 311 from an address value of the end position information 312. The decryption unit 202 decrypts only the data length of the encrypted communication control information 320 (S405) when analyzing that the data length of the encrypted communication control information 320 is a multiple of the data length of the processing block used for encryption algorithm. The protocol conversion unit 203 newly creates plaintext communication control information 510 and pre-encrypted communication control information 520 by performing protocol conversion for the plaintext communication control information 310 and decrypted communication control information 500 that comply with the secure protocol for the terminal device on the external network to be compliant with the secure protocol used for the home network (S406) and separates the communication control information complying with the secure protocol used at home into plaintext communication control information 510 and pre-encrypted communication control information 520 (S407).

Then, the encryption unit 204 encrypts the pre-encrypted communication control information 520 and generates pre-encrypted communication control information 530 (S408). The packet construction unit 204b combines the plaintext communication control information 510, the pre-encrypted communication control information 530 and the encrypted user information 330, constructs the packet data 502 (S409) and completes the protocol conversion processing for encrypted communications.

When different encryption algorithm and encryption key are used at each side (Y in S904), the communication control information analysis unit 202a acquires the head position information 311 and the end position information 312 of the communication control information 320 (S905) and then acquires the head position information 313 and the end position information 314 of the user information 330 (S906).

The communication control information decryption unit 202b decrypts the data area between the head position of the encrypted communication control information 320 and the end position of the encrypted user information 330 (S907). The protocol conversion unit 203 performs protocol conversion for the plaintext communication control information 310 and the decrypted communication control information 320 complying with the secure protocol used for the external network to those complying with the secure protocol used at home (S908) and separates the communication control information compliant with the secure protocol used at home into plaintext communication control information 510 and pre-encrypted communication control information 520 (S909).

Then, the communication control information encryption unit 204a encrypts the converted pre-encrypted communication control information 520 and the decrypted user information 2230 using information included in an encryption table 1401 (S910). The packet construction unit 204b then combines the plaintext communication control information 510, the encrypted communication control information 530 and the encrypted user information 330 (S409) and completes the protocol conversion for encrypted communications.

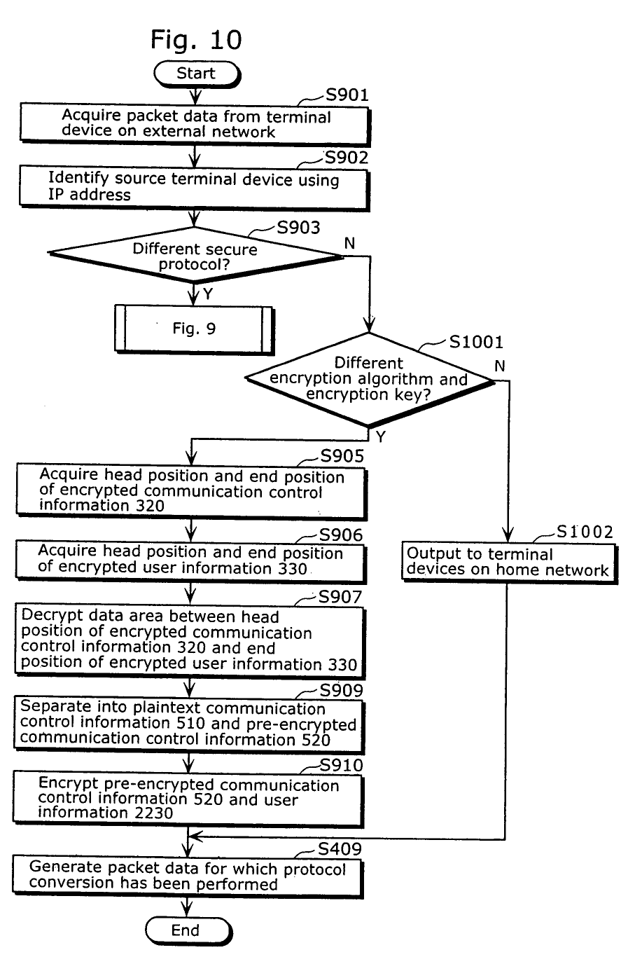

FIG. 10 is a flowchart according to the second embodiment showing an operation procedure of the packet routing device 101 when transmitting the packet data 301 from the terminal device on the external network to the terminal devices on the home network. The flowchart shows the case in which the secure protocol used for communications via the external network and the one used for the network at home are the same.

Firstly, the first network I/F unit 201 acquires the packet data 301 (S901) when the packet data is transmitted from the terminal device on the external network. The decryption unit 202 reads out the communication control information 310 from the packet data 301 transmitted from the first network I/F unit 201 and acquires an IP address of the source terminal device. The decryption unit 202 also identifies the source terminal device (S902) as well as the destination terminal devices and the secure protocol used for the terminal devices at home, with reference to the acquired IP address and the table 802 memorized by the memorizing unit 801 (S903). The diagram describes the case in which the protocols used at the both sides are the same (N in S903).

The decryption unit 202 then compares the encryption algorithm and the encryption key used for the secure protocol for the terminal device on the external network and those used for the secure protocol for the terminal devices at home (S904). When the same encryption algorithm and encryption key are used at the both sides (Y in S1001), the second network I/F unit 205 outputs the packet data received from the terminal device on the external network to the destination terminal devices at home (S1002).

On the other hand, when different encryption algorithm and encryption key are used at each side (Y in S1001), the second network I/F unit 205 acquires the head position information 311 and the end position information 312 of the communication control information 320 (S905) and then acquires the head position information 313 and the end position information 314 of the user information 330 (S906).

The communication control information decryption unit 202b decrypts the data area between the head position of the encrypted communication control information 320 and the end position of the encrypted user information 330 (S907). The protocol conversion unit 203, which does not need to perform protocol conversion for the packet data since the secure protocol for the terminal device on the external network and the one used for the terminal devices at home are the same, separates the communication control information compliant with the secure protocol used for the home network into plaintext communication control information 510 and pre-encrypted communication control information 520 (S909).

The communication control information encryption unit 204a encrypts the encrypted communication control information 520 and the decrypted user information 2230 with reference to the encryption table 1401 using the encryption algorithm used for the home network (S910). The packet construction unit 204b combines the plaintext communication control information 510, the encrypted communication control information 530 and the encrypted user information 330, generates the packet data 2202 (S409) and completes the protocol conversion processing for encrypted communications.

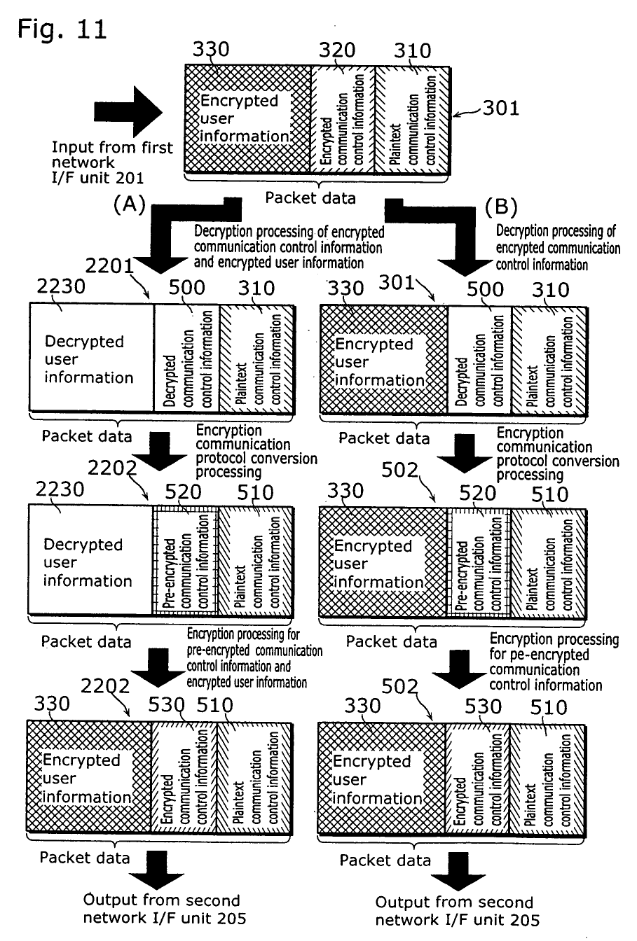

FIG. 11 is an illustration showing a process of protocol conversion processing of the packet data 301 performed by the packet routing device 101 according to the second embodiment. The packet data 301 is inputted from the terminal device on the external network to the first network I/F unit 201. The encrypted user information 330 includes information on a recording time of the TV program, a title of the program to be recorded, and the like. FIG. 11 is a referential diagram for the case in which the secure protocol used for the transmissions via the external network and the one used for the transmissions via the home network are different.

(A) in FIG. 11 describes the case in which the secure protocol, the encryption algorithm and the encryption key used for the transmissions via the external network and those used for the transmissions via the network at home are different. The packet routing device 101 acquires the head position information 311 and the end position information 312 of the encrypted communication control information 320 from the plaintext communication control information 310, obtains the data length of the encrypted communication control information 320, and decrypts the encrypted communication control information 320 and the encrypted user information 330. The packet routing device 101 then performs protocol conversion for the decrypted communication control information 500 and the plaintext communication control information 310 as the pre-encrypted communication control information 520 and the plaintext communication control information 510. Then, the pre-encrypted communication control information 520 and the decrypted user information 2230 are encrypted respectively as encrypted communication control information 530 and the encrypted user information 330. The packet construction unit 204b constructs packet data 2202 including the plaintext communication control information 510, the encrypted communication control information 530 and the encrypted user information 330 and outputs it from the second network I/F unit 205.

(B) in FIG. 11 shows the case in which the secure protocol used for the external network and the one used for the home network differ but the encryption algorithms and the encryption keys are the same. The packet routing device 101 acquires the head position information 311 and the end position information 312 of the encrypted communication control information 320 from the plaintext communication control information 310, obtains the data length of the encrypted communication control information 320 and decrypts only the part of the encrypted communication control information 320 as decrypted communication control information 500. The packet routing device 101 then performs protocol conversion for the decrypted communication control information 520 and the plaintext communication control information 310 respectively as pre-encrypted communication control information 520 and plaintext communication control information 510. Thus, only the part of the pre-encrypted communication control information 520 is encrypted as encrypted communication control information 530. Then, packet data 502 including the plaintext communication control information 510, the encrypted communication information 530 and the encrypted user information 330 is constructed and then outputted from the second network I/F unit 205 to the terminal devices at home.

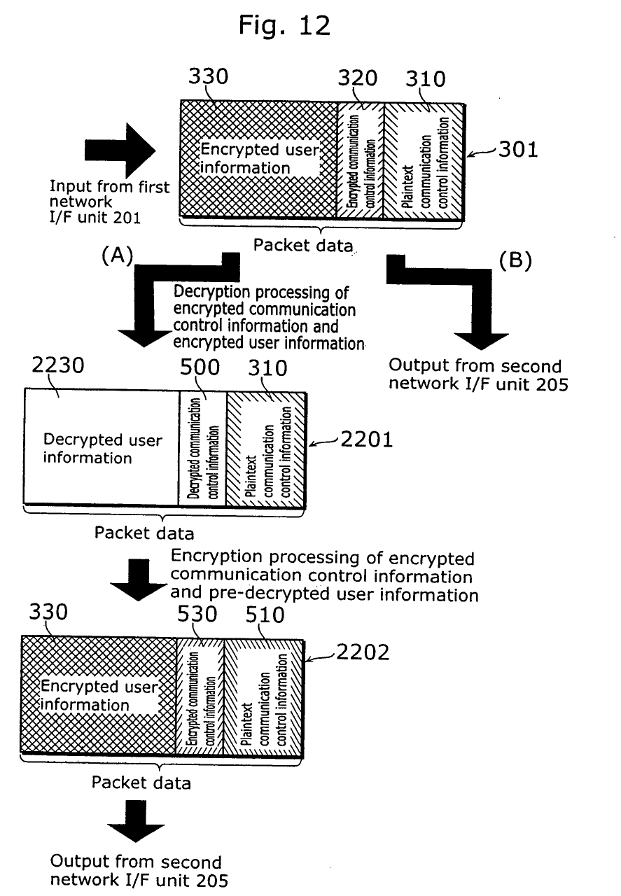

FIG. 12 is an illustration showing a process of another protocol conversion processing of the packet data 301 in the packet data routing device 101 according to the second embodiment. It is a referential diagram showing the case in which the secure protocol used for the transmissions via the external network and the one used for the transmissions via the home network are the same.

As shown in (A) of FIG. 12, when the secure protocols are the same but the encryption algorithms and the encryption keys are different, the packet routing device 101 acquires the head position information 311 and the end position information 312 of the encrypted communication control information 320 from the plaintext communication control information 310, obtains the data length of the encrypted communication control information 320 and decrypts both the encrypted communication control information 320 and the user information 330. The protocol conversion unit 203 does not perform protocol conversion for a packet data 2201 since the secure protocols are the same, but transmits it to the encryption unit 204 so that the decrypted communication control information 500 and the decrypted user information 2230 are encrypted respectively as encrypted communication control information 530 and the encrypted user information 330. The packet construction unit 204b constructs packet data 2202 including the plaintext communication control information 510, the encrypted communication control information 530 and the encrypted user information 330 and outputs it from the second network I/F unit 205 to the terminal devices at home.

As shown (B) of FIG. 12, when the secure protocol, the encryption algorithm and the encryption key are the same, the packet routing device 101 identifies the destination terminal devices at home and outputs the packet data 301, received by the first network I/F unit 201 from the second network I/F unit 205, to the destination terminal devices on the home network.

Thus, the packet routing device 101 according to the second embodiment includes the memorizing unit 801 memorizing the table 802 that indicates the IP addresses of the terminal devices on the external network, the secure protocols, the encryption algorithms and the encryption keys used for the transmissions as well as the protocol conversion unit 203 for converting, with reference to the table 802, the secure protocol for the packet data transmitted from the external network into the secure protocol used for the home network.

Therefore, when the packet data is transmitted with the control information attached from the terminal device which performs encrypted communications using various kinds of secure protocols from the place where the user has gone, such as a PC 701, a cell phone 702 or the like to the home electric appliances, the packet routing device 101 can convert a plurality of secure protocols for the packet data to be transmitted from the external network into a secure protocol used for a home network and route the packet data to the terminal devices at home. This allows the user to remote control safely the home electric appliances using the various terminal devices from outside and improves the convenience for the user.

The home electric appliances themselves connected to the home network do not have to have a protocol conversion function since the packet routing device 101 performs protocol conversion integrally, and the cost of the home electric appliances can be reduced.

In the case of transmitting the packet data to which the information is attached from the terminal device on the home network to the terminal device on the external network, the packet routing device 101 can convert the packet data into the one complying with the secure protocol used for the destination external network, therefore, the packet data to be outputted from the home electric appliances can be safely transmitted.

The packet routing device 101 does not have to perform the decryption and encryption processing for the whole packet data as has been the case by judging whether or not the secure protocol, the encryption algorithm and the encryption key are shared by each of the terminal devices connected via a communication network. Owing to this, the number of times executing the decryption processing which requires many processing steps can be reduced so that a high-speed protocol conversion processing can be realized even with the packet routing device 101 equipped with a low-priced and low-performance CPU.

In the present embodiment, the case of transmitting the packet data from the terminal device on the external network to the terminal devices on the home network, however, the packet routing device 101 is not restricted to this, and can surely transmit the packet data with the control information attached from the terminal device on the home network to the terminal device on the external network, convert the packet data into the one complying with a single secure protocol selected from the plurality of protocols and then transmit it to the terminal device on the external network.

(Third Embodiment)

The following illustrates a packet routing device 101 according to a third embodiment of the present invention. The third embodiment describes only the case in which the data length of the encrypted communication control information 320 is a multiple of the data length of the processing block used for encryption algorithm.

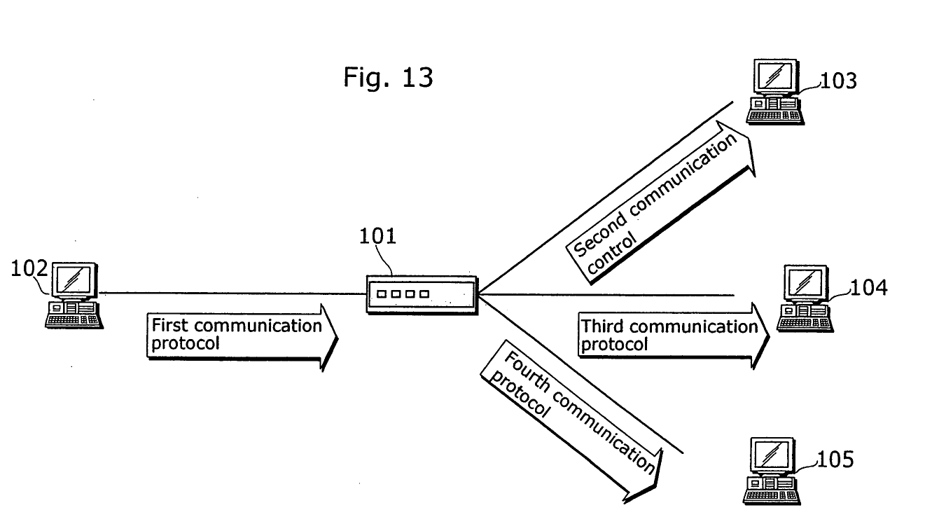

FIG. 13 is an example showing a structure of a network system including a packet routing device 101 according to the third embodiment. Since the encrypted communication protocols used respectively for terminal devices 102, 103, 104 and 105 shown in FIG. 13 are different, the packet routing device 101 that can understand the different encryption protocols and convert one encrypted communication protocol to the other is installed in the present embodiment.

The packet routing device 101 of the first embodiment assumes that the terminal devices 102 and 103 used for encrypted communications in order to perform protocol conversion share the encryption algorithm and the encryption key. However, in the network system of the third embodiment, it is assumed that the terminal devices 102, 103, 104 and 105 do not share them.

The first terminal device 102 is connected to the second terminal device 103, the third terminal device 104 and the fourth terminal device 105 via the packet routing device 101 so as to establish a network. The packet routing device 101 performs processing of decryption, protocol conversion and encryption as performed by the packet routing device 101 according to the first embodiment.

The first terminal 102 shown in FIG. 13 is connected to a first network and uses a first communication protocol for the encrypted communications. The second terminal device 103 is connected to a second network and uses a second communication protocol whereas a third terminal device 104 is connected to a third network and uses a third communication protocol and a fourth terminal device 105 is connected to a fourth network and uses a fourth communication protocol, for the encrypted communications. The first network is, for example, Internet and each of the second, third, and fourth networks is a communication network for the home use such as ECONET.

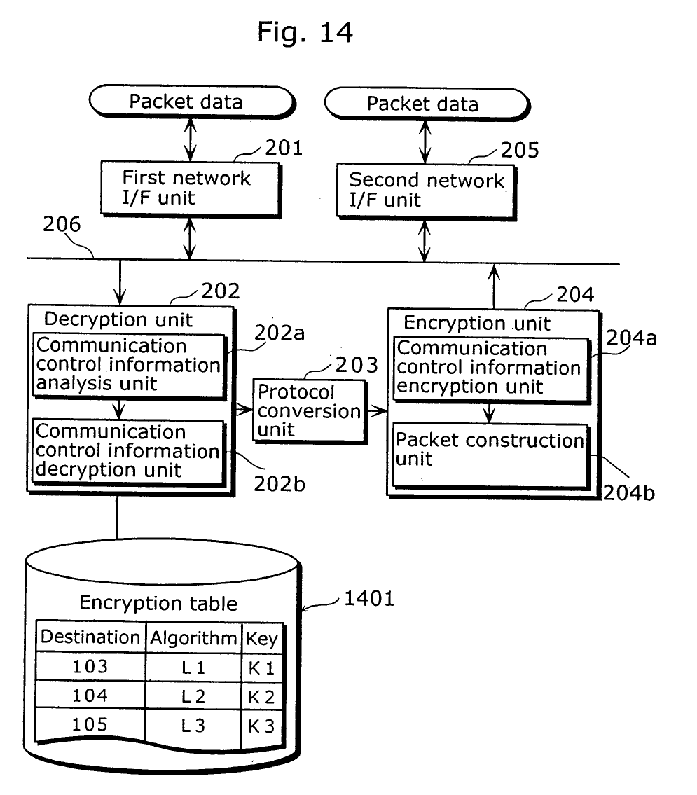

FIG. 14 is a functional block diagram showing a structure of the packet routing device 101 according to the third embodiment. The structure shown in FIG. 14 is an example for the description of the third embodiment, therefore, the structure of the packet routing device 101 is not limited to the one shown in FIG. 14. The following focuses on the differences between the first and the third embodiments.

The packet routing device 101 of the third embodiment includes the first network I/F unit 201, the decryption unit 202, the protocol conversion unit 203, the encryption unit 204, the second network I/F unit 205 and the bus 206 for transmitting the packet data 301. In the third embodiment, the packet routing device 101 further includes an encryption table 1401 incorporated in the ROM, IC card or the like. Each of the units included in the packet routing device 101 of the third embodiment performs the same processing as in the first embodiment.

The encryption table 1401 indicates information on the encryption algorithms and the encryption keys used for the second terminal device 103, the third terminal device 104 and the fourth terminal device 105. To be more precise, the encryption table 1401 shows that the encryption algorithm is L1 and the encryption key is K1 for the second terminal device 103, the encryption algorithm is L2 and the encryption key is K2 for the third terminal device 104 and the encryption algorithm is L3 and the encryption key is K3 for the fourth terminal device 105. Therefore, each of the terminal devices 103, 104 and 105 employs different encryption algorithm and encryption key.

The communication control information analysis unit 202a included in the decryption unit 202 judges whether or not each of the communication protocols shares the encryption algorithm and the encryption key, with reference to identifying information for the encryption algorithm and the one for the encryption key contained in the plaintext control information 310. After that, the communication control information decryption unit 202b decrypts the communication control information.

The conversion unit 203 then converts the decrypted communication control information into the communication control information complying with each of the communication protocols used for the terminal devices 103, 104 and 105 connected to the packet routing device 101. The packet construction unit 204b included in the encryption unit 204 generates packet data including the converted communication control information as well as the user information and outputs the generated packet data to the terminal devices 103, 104 and 105.

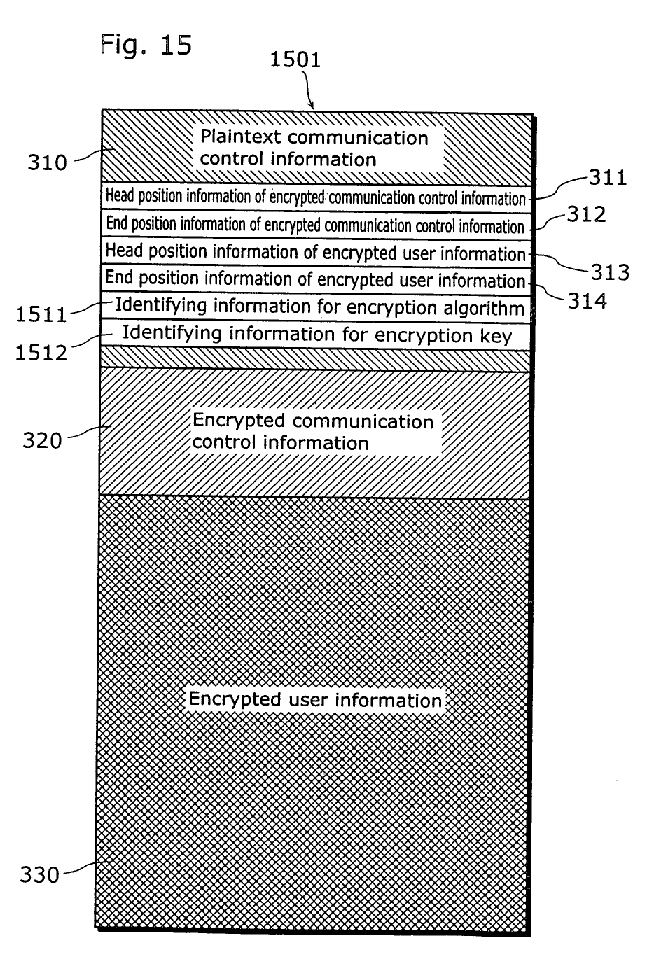

FIG. 15 is a diagram showing a data structure of a packet data 1501 used in the third embodiment. The following focuses on the differences between the first and the third embodiments. The size of the packet data 1501 is, for instance, 1500 bytes, and includes the plaintext communication control information 310, the encrypted communication control information 320 and the encrypted user information 330.

The packet data 1501 of the third embodiment includes not only the information contained in the packet data 301 described in the first embodiment but also the identifying information for the encryption algorithm 1511 and the identifying information for the encryption key 1512 included in the plaintext communication control information 310. The identifying information 1511 for the encryption algorithm identifies the encryption algorithm complying with the first terminal device 102 whereas the identifying information 1512 for the encryption key identifies the encryption key complying with the first terminal device 102.

The following illustrates an operation of the packet routing device 101 according to the third embodiment constructed as above.

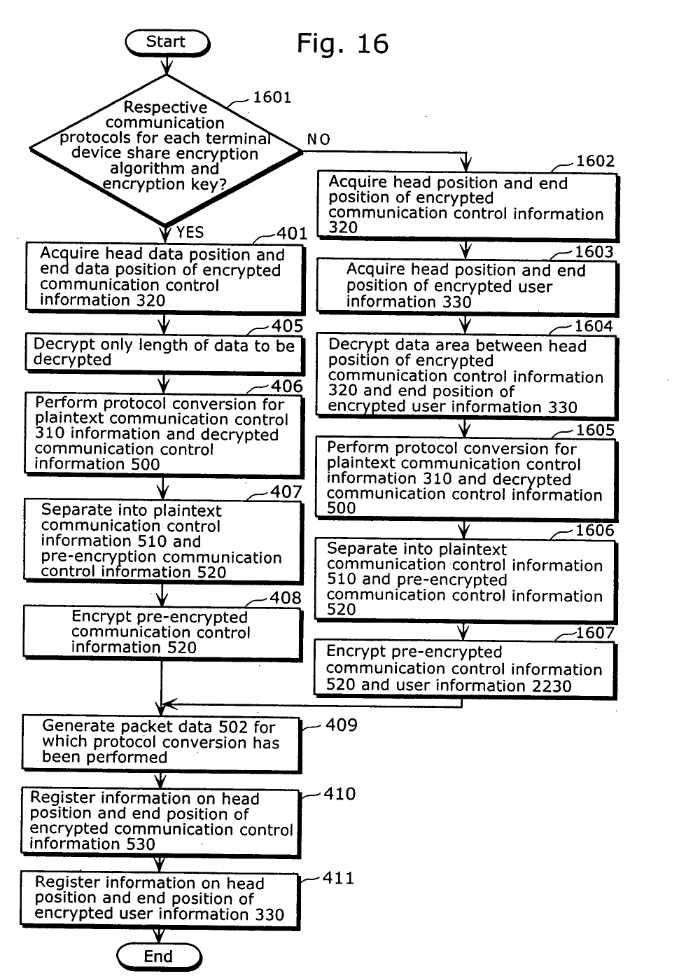

FIG. 16 is a flowchart showing an operation procedure of the packet routing device 101 according to the third embodiment. The packet routing device 101 according to the third embodiment has not only the function of the decryption unit 202 of the first embodiment but also the method to judge whether or not respective communication protocols share the encryption algorithm and the encryption key (Step 1601). To be more concrete, the communication control information analysis unit 202a judges whether or not each of the terminal devices 102, 103, 104 and 105 of each of the communication protocols share the encryption algorithm and the encryption key by using the encryption algorithm identifying information 1511 and the encryption key identifying information 1512 included in the plaintext communication control information 310 of the packet data 1501 received from the first terminal device 102 as well as the encryption table 1401 (Step 1601).

When it is judged that the terminal devices connected via the packet routing device 101 do not share the encryption algorithm and the encryption key, the communication control information analysis unit 202a acquires the head position information 311 and the end position information 312 of the communication control information 320 (Step 1602) and then acquires the head position information 313 and the end position information 314 of the user information 330 (Step 1603).

The communication control information decryption unit 202b decrypts the data area between the head position of the encrypted communication control information 320 and the end position of the encrypted user information 330 (Step 1604). The protocol conversion unit 203 performs protocol conversion for the communication control information 310 as well as the decrypted communication control information 320 complying with the first communication protocol into those complying with the second, third and fourth communication protocols and generates newly communication control information 520 (Step 1605). The protocol conversion unit 203 then separates the communication control information compliant with the second communication protocol into plaintext communication control information 510 and pre-encrypted communication control information 520 (Step 1606).

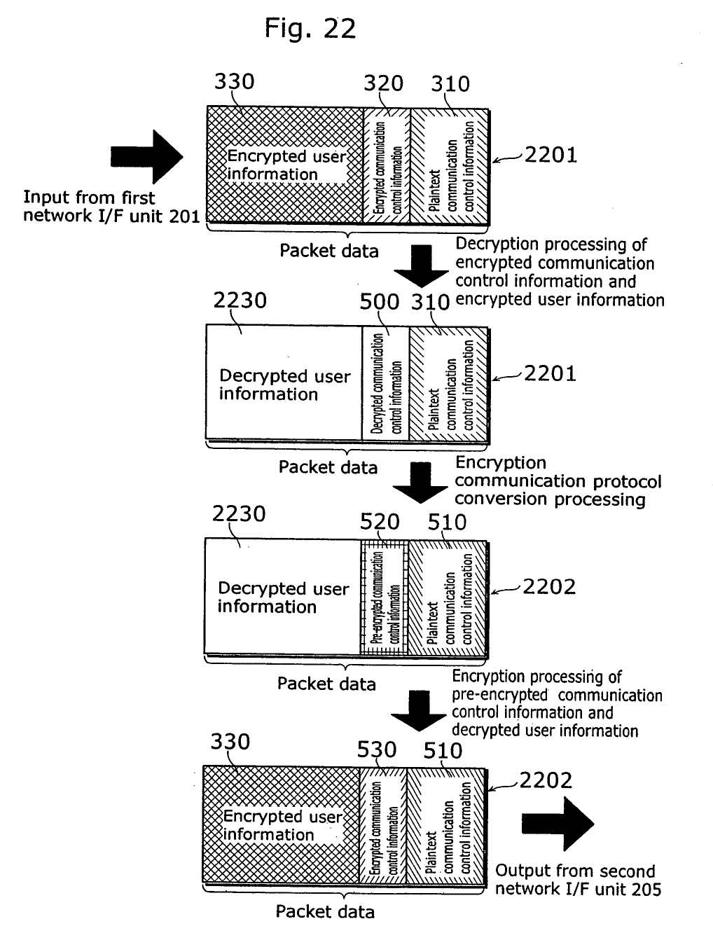

Then, the communication control information encryption unit 204a encrypts the converted encrypted communication control information 520 and the decrypted user information 2230 using the encryption table 1401 (Step 1607), as shown in FIG. 22. The packet construction unit 204b combines the plaintext communication control information 510, the encrypted communication control information 530 and the encrypted user information 330 and generates packet data 2202 (Step 409).

Then, the packet construction unit 204b registers, respectively in the plaintext communication control information 510, the head position and the end position of the encrypted communication control information 530 (Step 410) and also the head position and the end position of the encrypted user information 330 (Step 411). When this registration (Step 411) is terminated, the packet data 502 is constructed and a sequence of the protocol conversion for encrypted communications is thereby completed.

When it is judged that the terminal devices being connected to one another via the packet routing device 101 share the encryption algorithm and the encryption key (Step 1601), the following steps are the same as shown in the first embodiment. The communication control information analysis unit 202a acquires the head position information 311 and the end position information 312 of the encrypted communication control information 320 from the plaintext communication control information 310 included in the packet data 301 (Step 401). The decryption unit 202 decrypts only the data length of the encrypted communication control information 320 (Step 405). Then, the protocol conversion unit 203 generates newly the plaintext communication control information 510 and the pre-encrypted communication control information 520 by converting the plaintext communication control information 310 and the decrypted communication control information 500 complying with the first communication protocol into those complying with the second communication protocol (Step 406) and then separates the communication control information compliant with the second communication protocol into the plaintext communication control information 510 and the pre-encrypted control information 520 (Step 407).

Then, the encryption unit 204 encrypts the pre-encrypted communication control information 520 and generates the encrypted communication control information 530 (Step 408). Then, the packet construction unit 204b combines the plaintext communication control information 510, the encrypted communication control information 530 and the encrypted user information 330 and generates the packet data 502 (Step 409). The packet construction unit 204b then registers, respectively in the plaintext communication control information 510, the head position and the end position of the encrypted communication control information 530 (Step 410) and also the head position and the end position of the encrypted user information 330 (Step 411). A sequence of the protocol conversion for encrypted communications is thus completed when the packet data 502 is constructed.

Thus, according to the packet routing device 101 of the third embodiment, the packet data 1501 has the encryption algorithm identifying information 1511 that identifies the encryption algorithm and the encryption key identifying information 1512 that identifies the encryption key, of the first terminal device 102. Also, the packet routing device 101 includes the encryption table 1401 indicating the encryption algorithm and the encryption key used for the second terminal device 103, the third terminal device 104 and the fourth terminal device 105.

Consequently, the packet routing device 101 according to the third embodiment, which performs protocol conversion, judges whether or not each of the terminal devices 102, 103, 104 and 105 share the encryption algorithm and the encryption key in the network where various kinds of encryption algorithms and encryption keys coexist such as the case in which the terminal devices 102 and 103 share the encryption algorithm, the case in which they do not share it or the case in which they share the encryption algorithm but not the encryption key, for partly decrypting the packet data. When it is judged that they share the encryption algorithm and the encryption key, there is no need to decrypt the user information 330. Thus, the packet routing device 101 of the third embodiment performs protocol conversion after decrypting only the communication control information 320 and can thus encrypt only the part which needs to be encrypted in the communication control information 520 for which the conversion is performed. This does not require the decryption of the user information 330 that has a greater data amount compared with the communication control information 320 and reduces the number of executions for the decryption processing having many processing steps and thereby realizes a high-speed protocol conversion processing even with a cheap and low-performance CPU.

When judging that the first terminal device 102 and each of the terminal devices 103, 104 and 105 connected via encrypted communication do not share the encryption algorithm and the encryption key, the packet routing device 101 acquires the head position and the end position of the communication control information 320 by decrypting not only the communication control information 320 but also the user information 330, of the packet data 1501, performs protocol conversion for the communication control information 320 to be compliant with respective communication protocols for each of the terminal devices, and furthermore, performs encryption in compliance with the encryption algorithm and the encryption key used for each of the terminal devices.

Thus, the packet routing device 101 does not need to decrypt the whole area of the packet data as has been the case by judging whether or not respective terminal devices connected to one another via a communication network share the encryption algorithm and the encryption key. This reduces the number of executions for decryption processing which requires many processing steps and thereby realizes a high-speed protocol conversion processing even with the low-priced and low-performance CPU. Therefore, it is possible to provide a packet routing device adapted to the recent communication network system in which the encryption algorithms and the encryption keys used for each terminal device coexist.

However, the position information 311, 312, 313 and 314 included in the plaintext communication control information 310 as well as the identifying information 1511 and 1512 shown in the third embodiment are the examples and the types of information shall not be limited to these. The various kinds of information contained in the packet data according to the third embodiment are exemplified for the description and information other than the plaintext communication control information 310, the encrypted communication control information 320 and the user information 330 may be included. Furthermore, the position of these information is not limited to the one illustrated in the present embodiment, and a different structure may be applied instead.

Also, the encryption algorithm identifying information 1511 and the encryption key identifying information 1512 are described as separate information in the present embodiment, however, they may be put together.

(Fourth Embodiment)

Next, the following describes a packet routing device 101 according to a fourth embodiment. In the first and the third embodiments, for example, the DES, the 3DES, the AES or the like, with the ECB mode, which does not require other encryption results, are employed as an encryption algorithm for encrypting the packet data 301. However, the fourth embodiment assumes the case of employing an encryption algorithm, for instance, CBC (Cipher Block Chaining) mode, CFB (Cipher Feed Back) mode or the like, which requires encrypted information having the data length of the processing block used for encryption algorithm preceding the encrypted/decrypted communication control information by one block. The present embodiment shows a case in which the data length of the communication control information 320 is a multiple of the data length of the processing block used for encryption algorithm 601 to make the description easy to understand.

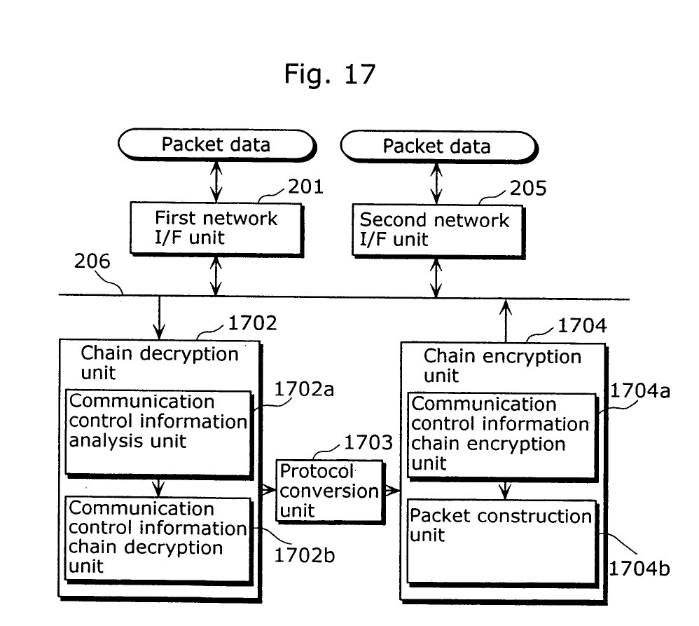

FIG. 17 is a functional block diagram showing a structure of the packet routing device 101 according to the fourth embodiment. Each component shown in FIG. 17 is an example for the description of the fourth embodiment and thereby the structure of the packet routing device 101 is not limited to the one shown in FIG. 17.

The packet routing device 101 includes the first network I/F unit 201, a chain decryption unit 1702, a protocol conversion unit 1703, a chain encryption unit 1704, the second network I/F unit 205 and the bus 206 for transmitting packet data 1801.

The chain decryption unit 1702, including a communication control information analysis unit 1702a and a communication control information chain decryption unit 1702b, decrypts the packet data 1801 received by the first network I/F unit 201 (or the second network I/F unit 205) complying with the first encrypted communication protocol and outputs it to the protocol conversion unit 1703. The communication control information analysis unit 1702a analyzes the data length of the encrypted communication control information 320 using the plaintext communication control information 310 included in the packet data 1801 and then the communication control information chain decryption unit 1702b chain decrypts the length of the data which needs to be decrypted starting from the head position of the encrypted communication control information 320 by using the information having the data length of the processing block used for encryption algorithm and preceding the encrypted/decrypted communication control information by one block.

The protocol conversion unit 1703 receives the packet data 1801 outputted from the chain decryption unit 1702, performs protocol conversion so that it is compliant with a different encryption protocol and outputs the result to the chain encryption unit 1704.

The chain encryption unit 1704 includes a communication control information encryption unit 1704a and a packet construction unit 1704b. The communication control information encryption unit 1704a performs chain encryption processing for the packet data 1801 for which protocol conversion is performed by the protocol conversion unit 1703, with reference to the information having the data length of the processing block used for encryption and preceding the encrypted/decrypted communication control information by one block whereas the packet construction unit 1704b constructs packet data 1802 and outputs it to the second network I/F unit 205.

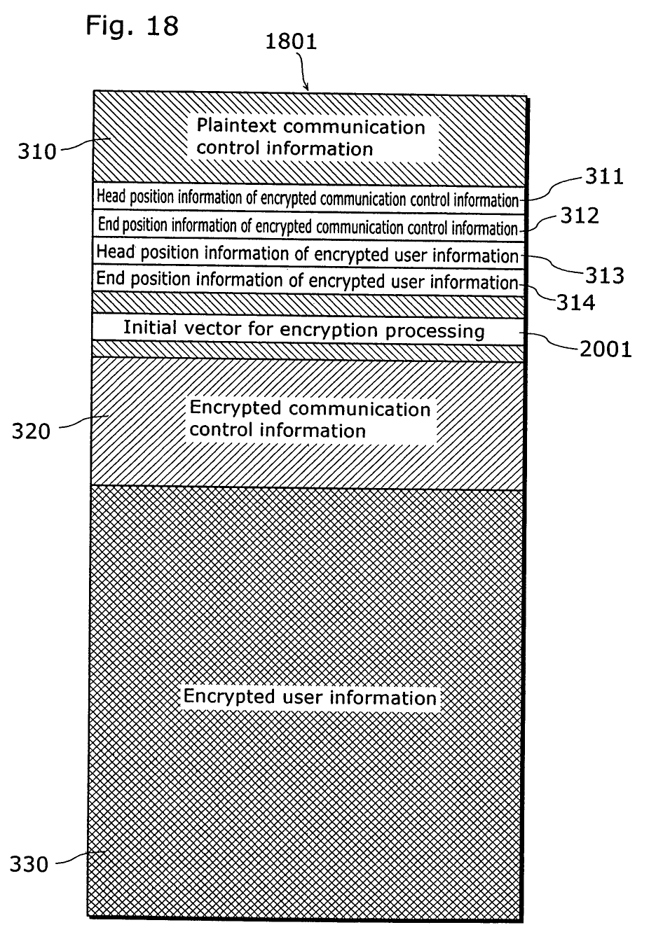

FIG. 18 is a diagram showing a data structure of the packet data 1801 used in the fourth embodiment. The packet data 1801 includes not only the information contained in the packet data 301 of the first embodiment but also an initial vector for encryption processing 2001 in the plaintext communication control information 310. The initial vector for encryption processing 2001 is information necessary for decrypting the encrypted communication control information 320.

The following describes an operation of the packet routing device 101 according to the fourth embodiment.

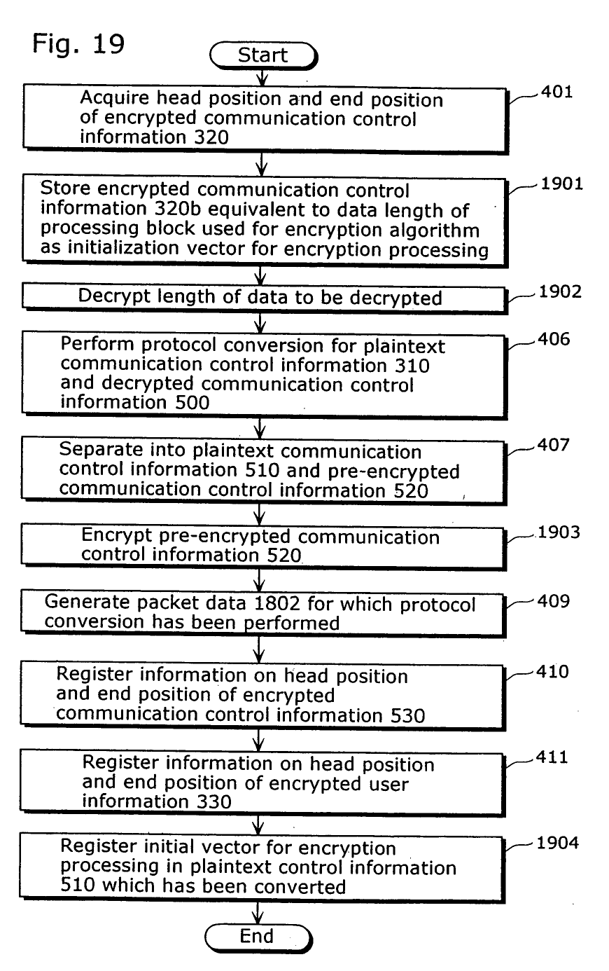

FIG. 19 is a flowchart showing an operation procedure of the packet routing device 101 according to the fourth embodiment. Firstly, the communication control information analysis unit 1702a acquires the head position information 311 and the end information position 312 of the encrypted communication control information 320 from the plaintext communication control information 310 included in the packet data 1801 transmitted from the first network I/F unit 205 (Step 401) The communication control information analysis unit 1702a then temporally stores encrypted communication control information 320b in a free space within a RAM as an initial vector for encryption processing 2002 so that the user information 330 can be decrypted by the receiving terminal (Step 1901). Then, the communication control information chain decryption unit 1702b decrypts encrypted communication control information 320a using the initial vector for encryption processing 2001 included in the plaintext communication control information 301 and obtains decrypted communication control information 500a. The communication control information chain decryption unit 1702b also chain decrypts the encrypted communication control information 320b using the encrypted communication control information 320a and obtains the decrypted communication control information 500b. Then, decryption is performed only for the data length to be decrypted (Step 1902). After that, the protocol conversion unit 1703 generates newly pre-encrypted communication control information 520 compliant with the second communication protocol (Step 406) and separates the communication control information compliant with the second communication protocol into plaintext communication control information 510 and pre-encrypted communication control information 520 (Step 407).

Then, the communication control information chain encryption unit 1704a included in the chain encryption unit 1704 encrypts the communication control information 520a equivalent to the data length of the encryption processing block of the communication control information 520 with the use of the initial vector for encryption processing 2002 and obtains communication control information 530a. Furthermore, the communication control information chain encryption unit 1704a chain encrypts the communication control information 520b using the communication control information 520a and obtains communication control information 530b (Step 1903). Then, the packet construction 1704b combines the plaintext communication control information 510, the encrypted communication control information 530 and the encrypted user information 330 and generates packet data 1802 (Step 409).

The packet construction unit 1704b registers, respectively in the plaintext communication control information 510, the information on the head position and the end position of the encrypted communication control information 530 (Step 410) as well as the information on the head position and the end position of the encrypted user information 330 (Step 411). Also, the packet construction unit 1704b registers the initial vector for encryption processing 2002 temporally stored in the plaintext communication control information 510 into a predetermined position within the plaintext communication control information 510 (Step 1904). Thus, the construction of the packet data 1802 is achieved, and a sequence of the protocol conversion for encrypted communications is completed.

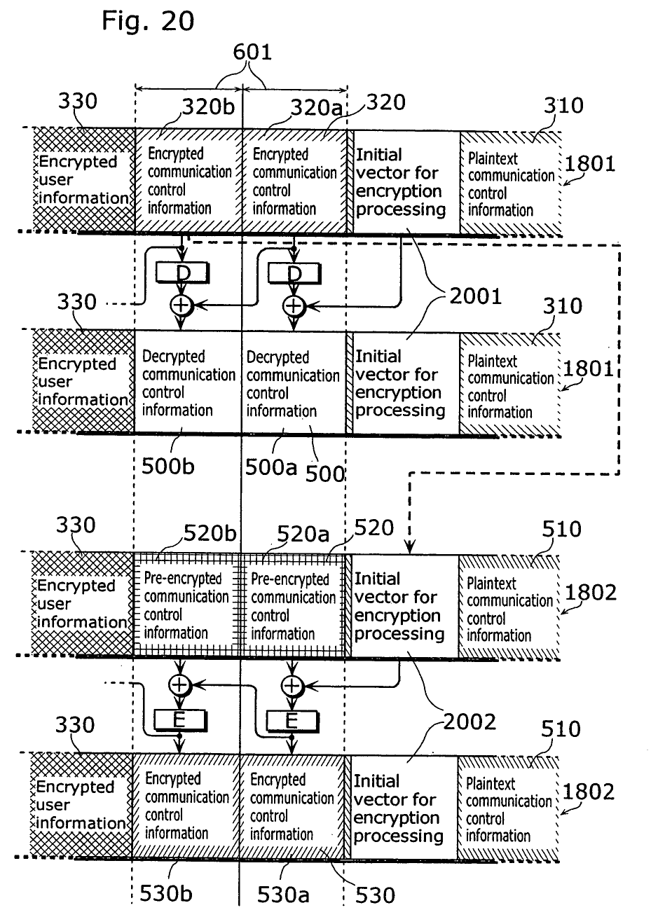

FIG. 20 is an illustration showing a process of packet data processing of the packet routing device 101 according to the fourth embodiment. The packet data 1801 includes the plaintext communication control information 310, the encrypted communication control information 320 and the user information 330. The plaintext communication control information 310 further includes the initial vector for encryption vector 2001.

The packet routing device 101 acquires the head position information 311 and the end position information 312 of the encrypted communication control information 320 from the plaintext communication control information 310, obtains the data length of the encrypted communication control information 320 and decrypts only the part of the encrypted communication control information 320. As shown in FIG. 20, in this case, the communication control information 320a is decrypted as decrypted communication control information 500a by the fact that an exclusive disjunction between the decrypted communication control information 320a and the initial vector 2001 is carried out. The communication control information 320b is chain decrypted as decrypted communication control information 500b by the fact that the exclusive disjunction between the communication control information 320b and the communication control information 320a is carried out. The communication control information 320 is thus decrypted as decrypted communication control information 500 with the use of such a chain as described above.

Also, the encrypted communication control information 320b that is one block preceding the user information 330 is registered as an initial vector for encryption processing 2002 in the plaintext communication control information 510. The initial vector for encryption processing 2002 is also used for decrypting the encrypted user information 330. Then, the pre-decrypted communication control information 500 and the plaintext communication control information 310 are protocol converted as pre-encrypted communication control information 520 and the plaintext communication control information 510.

As shown in FIG. 20, the part of the pre-encrypted communication control information 520a is chain encrypted and becomes encrypted communication control information 530a after the exclusive disjunction is carried out using the initial vector for encryption processing 2002. The encrypted communication control information 520b is chain encrypted and becomes encrypted communication control information 530b after the exclusive disjunction between the encrypted communication control information 520b and the chain encrypted communication control information 530a is carried out. The pre-encrypted communication control information 520 is thus encrypted as the encrypted communication control information 530 using such a chain as described above.

Then, the packet data 1802 including the plaintext communication control information 510, the encrypted communication control information 530 and the encrypted user information 330 is constructed and outputted from the second network I/F unit 205. Thus, a sequence of processing of the protocol conversion for encrypted communications performed by the packet routing device 101 is completed.

In this way, with the use of the packet routing device 101 described in the fourth embodiment, the user information 330 having a greater data amount compared with the communication control information 320 is not decrypted even in the case in which an encryption processing mode such as the CBC mode, the CFB mode or the like, requiring the information previously encrypted by one block for the following encryption or decryption of the information, is employed as an encryption algorithm that can perform decryption partly. This reduces the number of executions for decryption processing which requires many processing steps and thereby can realize a high-speed protocol conversion processing even with the low-priced and low-performance CPU.

Also, during the processing of the packet data 1801 performed by the packet routing device 101 according to the fourth embodiment, the user information 330 remains encrypted so that highly confidential information can be hardly intercepted by a malicious third person.

The encryption algorithm and the encryption processing mode described in the present embodiment are merely the examples and other kinds may substitute them. Also, the initial vector for encryption processing 2002 is employed in order to encrypt the encrypted communication control information 520a in the present embodiment. However, a different initial vector for encryption processing can be provided and used in stead, and further out, may be added to the plaintext communication control information 510.

Also, the position of the position information 311, 312, 313 and 314 included in the plaintext communication control information 310 as well as the initial vector 2001 shown in the present embodiment are the examples and the structure shall not be limited to the one used in the present embodiment. The various kinds of information included in the packet data 1801 according to the present embodiment is exemplified for the description, and other information may be included. The position of the plaintext communication control information 310, the encrypted communication control information 320 and the user information 330 is not limited to the one described in the present embodiment and they may be placed differently.

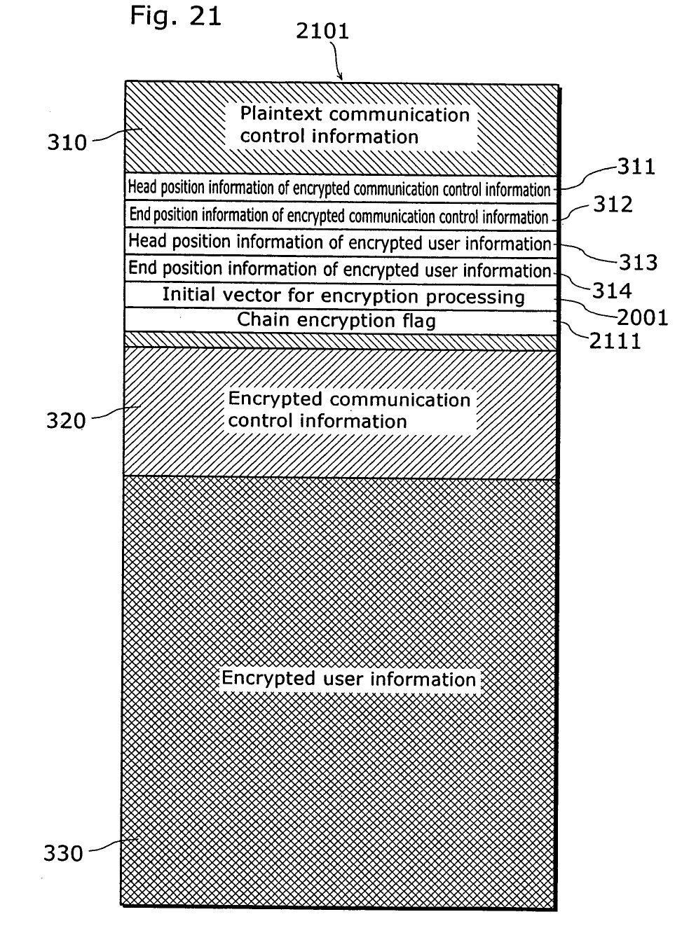

FIG. 21 shows an example of a data structure of the packet data 2101 used for the present invention. The packet data 2101 includes a chain encryption flag 2111 in the plaintext communication control information 310. The chain encryption flag 2111 is information indicating whether or not to chain decrypt the encrypted communication control information and the encrypted user information and judges which method to employ for calculating the exclusive disjunction when decrypting the head of the user information 330, using either the initial vector or the encrypted communication control information 320 preceding the user information 330 by one block. Thus, the decryption of the user information 330 is simplified and thereby unnecessary processing can be abbreviated.

With the packet routing device according to the present invention, the position information of the encrypted communication control information included in the received packet data is updated as the position information of the decrypted communication control information and can be stored again as new position information in a predetermined position within the packet data (i.e., plaintext communication control information). Therefore, it is conceivable to incorporate a storage position registration unit into the packet routing device according to the present invention.

Moreover, it is needless to say that the packet data 301, 1501 and 1801 can be stored in a storage medium like CD-ROM in order to make it computer-readable.

### INDUSTRIAL APPLICABILITY

The packet routing device according to the present invention is used for devices transmitting packet data via a network and can be applied especially as a packet routing device for transmitting the packet data between the device on an external network and the device(s) on a home network.

1. A packet routing device for routing packet data to be transmitted between a first terminal device on an external network and a second terminal device on a home network, comprising:
a reception unit operable to receive the packet data complying with one of a plurality of secure protocols from the first terminal device via the external network;
a judgment unit operable to judge types of secure protocols, encryption algorithms and encryption keys used for communications via the external network and communications via the home network;
a conversion unit operable to convert the secure protocol for the packet data received by the reception unit into a second secure protocol for the home network, based on the judgment made by the judgment unit; and
an outputting unit operable to output, to the second terminal device, the packet data whose protocol has been converted by the conversion unit.

2. The packet routing device according to claim 1, further comprising:
a source acquisition unit operable to acquire address information of the first terminal device that is a sender of the packet data received by the reception unit; and
a memorizing unit operable to memorize a table indicating at least the address information acquired by the source acquisition unit as well as the types of secure protocols, encryption algorithms and encryption keys, judged by the judgment unit,
wherein the conversion unit acquires the address information from the source acquisition unit, and converts, with reference to the table, the secure protocol for the packet data sent from the first terminal device on the external network into the secure protocol for the home network.

3. The packet routing device according to claim 1,
wherein the packet data received by the reception unit contains a header part including plaintext communication control information and encrypted communication control information, and a main part including encrypted user information, and
the packet routing device further comprises:
an identification unit operable to identify the encrypted communication control information from the received packet data;
a decryption unit operable to decrypt the identified encrypted communication control information; and
a packet generation unit operable to generate packet data whose protocol is converted by the conversion unit, the packet data including the decrypted communication control information and the user information,
wherein the conversion unit converts the communication control information decrypted by the decryption unit into communication control information complying with the second secure protocol, and
the outputting unit outputs the packet data generated by the packet generation unit to the second secure protocol.

4. The packet routing device according to claim 3,
wherein the judgment unit judges whether or not the first and the second terminal devices share a secure protocol, using the plaintext communication control information included in the header part, and
the conversion unit does not perform protocol conversion when the judgment unit judges that said first and second terminal devices share the secure protocol, but performs protocol conversion only for the header part when it is judged that said first and second terminal devices do not share the secure protocol.

5. The packet routing device according to claim 3,
wherein the judgment unit judges whether the first and the second terminal devices share a secure protocol, an encryption algorithm and an encryption key, using the plaintext communication control information included in the header part, and
when the judgment unit judges that said first and second terminal devices share the secure protocol, the encryption algorithm and the encryption key, the outputting unit outputs, to the second terminal device, the packet data received by the reception unit, without performing protocol conversion.

6. The packet routing device according to claim 3, further comprising:
an encryption unit operable to encrypt the decrypted communication control information decrypted by the decryption unit using the encryption algorithm and the encryption key used for the secure protocol for the home network based on the judgment made by the judgment unit, after the decrypted communication control information is converted, as a plaintext, into communication control information complying with the second secure protocol
the packet generation unit generates packet data including the communication control information encrypted by the encryption unit and the user information.

7. The packet routing device according to claim 6,
wherein the encryption algorithm for either of the following uses: for the decryption performed by the decryption unit and for the encryption performed by the encryption unit, is one of the followings: Data Encryption Standard (DES), Triple DES (3DES) and Advanced Encryption Standard (AES).

8. The packet routing device according to claim 3,
wherein the packet data received from the first terminal device further includes position information X indicating a storage position of the encrypted communication control information in the packet data, and
the identification unit identifies the encrypted communication control information based on the position information X.

9. The packet routing device according to claim 3,
wherein the packet data received from the first terminal device further includes position information Y indicating a storage position of the user information in the packet data, and
the identification unit identifies the user information based on the position information Y.

10. The packet routing device according to claim 3, further comprising a communication control information position registration unit operable to register, in the plaintext communication control information, information on head position and end position of the communication control information which has been protocol converted.

11. The packet routing device according to claim 3, further comprising a user information position registration unit operable to register, in the plaintext communication control information, information on head position and end position of the encrypted user information.

12. The packet routing device according to claim 3, further comprising an analysis unit operable to analyze whether or not an encryption block length of the communication control information is a multiple of a processing block used for encryption algorithm, and
wherein when the analysis unit analyzes that the encryption block length of the communication control information is a multiple of the processing block used for encryption algorithm, the decryption unit decrypts the analyzed communication control information, the conversion unit converts the decrypted communication control information into communication control information complying with the second secure protocol, the packet generation unit generates packet data including the converted communication control information and the user information, and then, the outputting unit outputs the generated packet data to the second terminal device, and
when the analysis unit analyzes that the encryption block length of the communication control information is not a multiple of the processing block used for encryption algorithm, the analysis unit sets a length of data to be decrypted so that said length of data becomes a multiple of the encryption algorithm, the decryption unit decrypts the communication control information and the user information, each of which is equivalent to the length of the data to be decrypted, the conversion unit converts the decrypted communication control information into communication control information complying with the second secure protocol and attaches padding data to the user information so that said user information becomes a multiple of the processing block used for encryption algorithm, the packet generation unit generates packet data including the converted communication control information and the user information, and then, the outputting unit outputs the generated packet data to the second terminal device.

13. The packet routing device according to claim 3,
wherein the judgment unit judges whether or not the first and the second terminal devices share an encryption algorithm and an encryption key, using the plaintext communication control information included in the packet data received from the first terminal device, and
when the judgment unit judges that said first and second terminal devices share the encryption algorithm and the encryption key, the identification unit identifies the encrypted communication control information from the packet data, the decryption unit decrypts the identified communication control information, the conversion unit converts the decrypted communication control information into communication control information complying with the second secure protocol, the packet generation unit generates packet data including the converted communication control information and the user information, and then, the outputting unit outputs the generated packet data to the second terminal device, and
when the judgment unit judges that said first and second terminal devices do not share the encryption algorithm and the encryption key, the decryption unit decrypts both the communication control information and the user information, the conversion unit converts the decrypted communication control information into communication control information complying with the second secure protocol, the packet generation unit generates packet data including the converted communication control information and the user information, and then, the outputting unit outputs the generated packet data to the second terminal device.

14. The packet routing device according to claim 13,
wherein the packet data received from the first terminal device further includes identifying information which identifies the encryption algorithm and the encryption key used for the secure protocol for the packet data, and
the judgment unit judges whether or not said secure protocol and the second secure protocol share the encryption algorithm and the encryption key based on the identifying information.

15. The packet routing device according to claim 3,
wherein the packet data received from the first terminal device includes an initial vector for decrypting head data of the encrypted communication control information in the packet data, and
the decryption unit decrypts the encrypted communication control information based on the initial vector.

16. The packet routing device according to claim 15, further comprising the following units when the decryption unit and the encryption unit require encrypted information having a data length of the processing block used for encryption algorithm and preceding the encrypted/decrypted communication control information by one block, for decrypting and encrypting said information:
an initial vector storage unit operable to store, in the plaintext communication control information, the encrypted communication control information as an initial vector necessary for decrypting head data of the user information, before the encrypted communication control information is decrypted, said encrypted communication control information preceding the user information by one block; and
an initial vector registration unit operable to register the initial vector stored in the initial vector storage unit in the plaintext communication control information converted, as a plaintext, in compliance with the second secure protocol.

17. The packet routing device according to claim 15,
wherein the packet data further includes a chain encryption flag indicating whether or not to chain decrypt the encrypted communication information and the encrypted user information, and
the decryption unit decrypts the encrypted user information based on the chain encryption flag.

18. The packet routing device according to claim 15,
wherein encryption algorithm for either of the following uses: for the decryption performed by the decryption unit and the encryption performed by the encryption unit, is one of the followings: DES-Cipher Block Chaining (CBC), 3DES-CBC and AES-CBC.

19. The packet routing device according to claim 3, further comprising a storage position registration unit operable to modify storage position information of the encrypted communication control information to storage position information of the decrypted communication control information, and register the modified storage position information in a predetermined position within the packet data.

20. The packet routing device according to claim 3, further comprising a second storage position registration unit operable to modify storage position information of the encrypted user information to storage position information of the decrypted user information, and register the modified storage position information in a predetermined position within the packet data.

21. The packet routing device according to claim 3,
wherein the packet routing device is connected to a plurality of terminal devices,
the conversion unit converts the decrypted communication control information to communication control information complying with a secure protocol for a destination terminal device connected to the packet routing device,
the packet generation unit generates packet data including the converted communication control information and the user information, and
the outputting unit outputs the generated packet data to the destination terminal device.

22. The packet routing device according to claim 1,
wherein the packet data received from the first terminal device further includes identifying information which identifies the secure protocol, the encryption algorithm and the encryption key, used for the secure protocol for the packet data, and
the judgment unit judges whether or not the external network and the home network share the secure protocol, the encryption algorithm and the encryption key, based on the identifying information.

23. The packet routing device according to claim 1, further comprising a destination identification unit operable to identify the first terminal device which is a destination of the packet data to be transmitted from the second terminal device on the home network,
wherein the conversion unit converts the secure protocol for the packet data into the secure protocol for the first terminal device on the external network, identified by the destination identification unit, and
the outputting unit outputs the packet data whose protocol is converted by the conversion unit to the first terminal device that is the destination in the external network.

24. The packet routing device according to claim 23,
wherein the conversion unit performs protocol conversion only for a header part of the packet data when the judgment unit judges that the second terminal device on the home network and the first terminal device on the external network do not share the secure protocol, but does not perform protocol conversion for the packet data when the judgment unit judges that the second terminal device on the home network and the first terminal device on the external network share the secure protocol.

25. A packet routing system for transmitting packet data via a packet routing device between a first terminal device on an external network and a second terminal device on a home network, the packet routing system comprising:
a reception unit operable to receive, from the first terminal device via the external network, the packet data complying with one of a plurality of secure protocols;
a judgment unit operable to judge types of secure protocols, encryption algorithms and encryption keys, used for communications via the external network and communications via the home network;
a conversion unit operable to convert a secure protocol for the packet data received by the reception unit into a second secure protocol for the home network, based on the judgment made by the judgment unit; and
an outputting unit operable to output, to the second terminal device, the packet data whose protocol has been converted by the conversion unit.

26. A packet routing method of routing packet data between a first terminal device on an external network and a second terminal device on a home network, the packet routing method comprising:
a reception step of receiving, from the first terminal device via the external network, the packet data complying with one of a plurality of secure protocols;
a judgment step of judging types of secure protocols, encryption algorithms and encryption keys, used for communications via the external device and communications via the home network;
a conversion step of converting a secure protocol for the packet data received in the reception step into a second secure protocol for the home network; and
an outputting step of outputting, to the second terminal device, the packet data whose protocol has been converted in the conversion step.

27. The packet routing method according to claim 26,
wherein the packet data received in the reception step contains a header part including plaintext communication control information and encrypted communication control information, and a main part including encrypted user information, and
the packet routing device further comprises:
an identification step of identifying the encrypted communication information from the received packet data;
a decryption step of decrypting the identified encrypted communication control information;
a packet generation step of generating packet data including the communication control information whose protocol is converted in the conversion step and the user information,
wherein in the conversion step, the communication control information decrypted in the decryption step is converted into communication control information complying with the second secure protocol, and
in the outputting step, the packet data generated in the packet generation step is outputted to the second terminal device.

28. A program for a packet routing device which outputs packet data received from a first terminal via an external network complying with one of a plurality of secure protocols to a second terminal device via a home network complying with a second secure protocol, the program causing a computer to execute all the units included in the packet routing device according to any one of claims 1 through 24.
